(19) United States
(12) Patent Application Publication
(10) Pub. No.: US 2017/0327097 A1
(43) Pub. Date: Nov. 16, 2017

(54) Brake Apparatus and Brake System

(71) Applicant: Hitachi Automotive Systems, Ltd., Hitachinaka-shi, Ibaraki (JP)

(72) Inventors: Masayuki SAITO, Machida-shi, Tokyo (JP); Chiharu NAKAZAWA, Kawasaki-shi, Kanagawa (JP)

(21) Appl. No.: 15/534,035

(22) PCT Filed: Nov. 27, 2015
(86) PCT No.: PCT/JP2015/083316

§ 371 Date: Jun. 8, 2017

(30) Foreign Application Priority Data
Dec. 12, 2014 (JP) 2014-251366

(51) Int. Cl. B60T 8/40; B60T 13/68; B60T 8/42; B60T 7/04

(52) U.S. Cl. CPC B60T 8/409; B60T 13/686; B60T 8/40; B60T 7/042; B60T 8/4291

(57) ABSTRACT

a brake apparatus capable of improving a brake operation feeling is provided. A brake apparatus includes a stroke simulator including a piston configured to be activated axially in a cylinder with use of brake fluid supplied from a master cylinder. The piston divides an inside of the cylinder into at least a positive pressure chamber and a backpressure chamber. The piston is configured in such a manner that a pressure-receiving area racing the backpressure chamber is smaller than a pressures-receiving area facing the positive pressure chamber. The stroke simulator is configured to generate, thorough the activation of the piston, an operation reaction force according to a brake operation performed by a driver. The brake apparatus further includes a second oil passage provided between the positive pressure chamber and the master cylinder, a third oil passage connecting between the backpressure chamber and the first oil passage, a fourth oil passage connecting between the backpressure chamber and the reservoir tank, and a switching unit configured to switch a connection of the backpressure chamber between a connection between the backpressure chamber and the first oil passage and a connection between the backpressure chamber and the reservoir tank.

### TECHNICAL FIELD

The present invention relates to a brake apparatus mounted on a vehicle.

### BACKGROUND ART

Conventionally, there has been known a brake apparatus that includes a stroke simulator for creating an operation reaction force according to a brake operation of a driver and is capable of generating a hydraulic pressure in a wheel cylinder with use of a hydraulic source provided separately from a master cylinder. For example, a brake apparatus discussed in PTL 1 includes an accumulator as the hydraulic source and provides hydraulic fluid discharged from the stroke simulator to the accumulator side.

### CITATION LIST

### Patent Literature

PTL 1: Japanese Patent Application Public Disclosure No. 2009-166739

### SUMMARY OF INVENTION

### Technical Problem

However, the conventional brake apparatus is configured to constantly supply the hydraulic fluid discharged from the stroke stipulator to the accumulator side, thereby making it difficult to secure an excellent brake operation feeling. An object of the present invention is to provide a brake apparatus capable of improving the brake operation feeling.

### Solution to Problem

To achieve the above-described object, a brake apparatus according to one embodiment of the present invention preferably includes a switching unit configured to switch a connection destination of a backpressure chamber of the stroke simulator to a wheel cylinder side or a low pressure portion side.

Therefore, the brake operation feeling can be improved.

BRIEF DESCRIPTION OF DRAWINGS

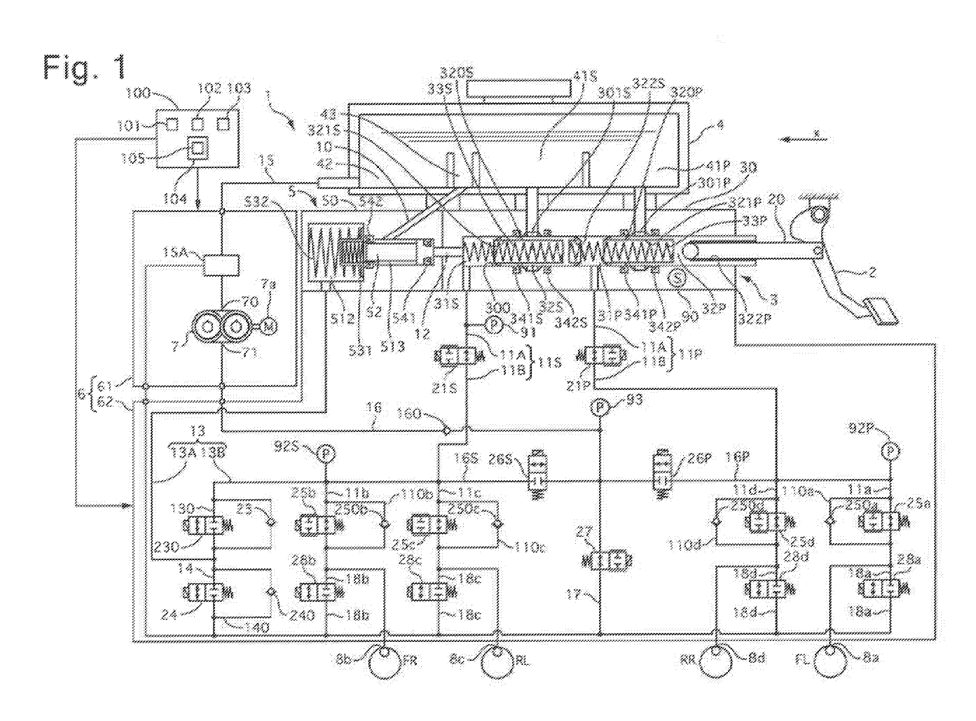

FIG. 1 schematically illustrates a configuration of a brake system according to a first embodiment.

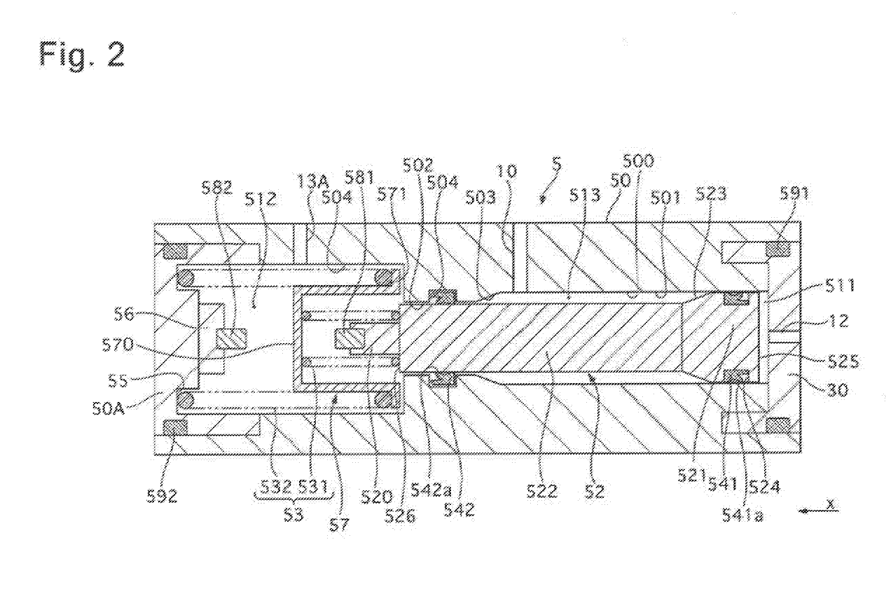

FIG. 2 schematically illustrates a configuration of a stroke simulator 5 according to the first embodiment.

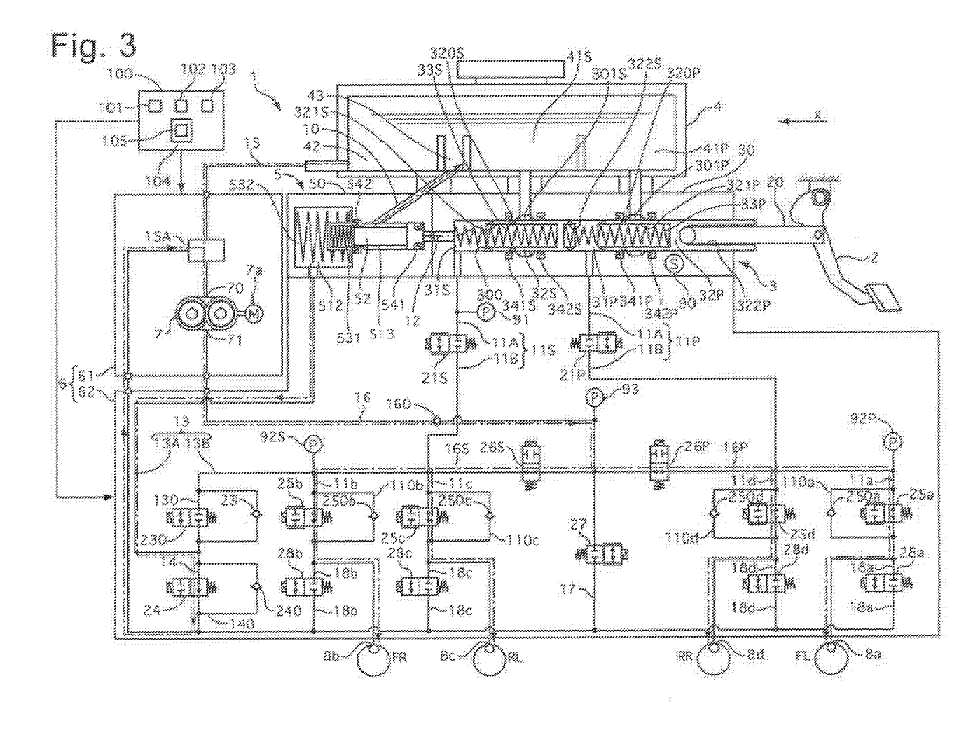

FIG. 3 illustrates an activation state of a brake apparatus 1 according to the first embodiment at the time of normal wheel cylinder pressure increase control.

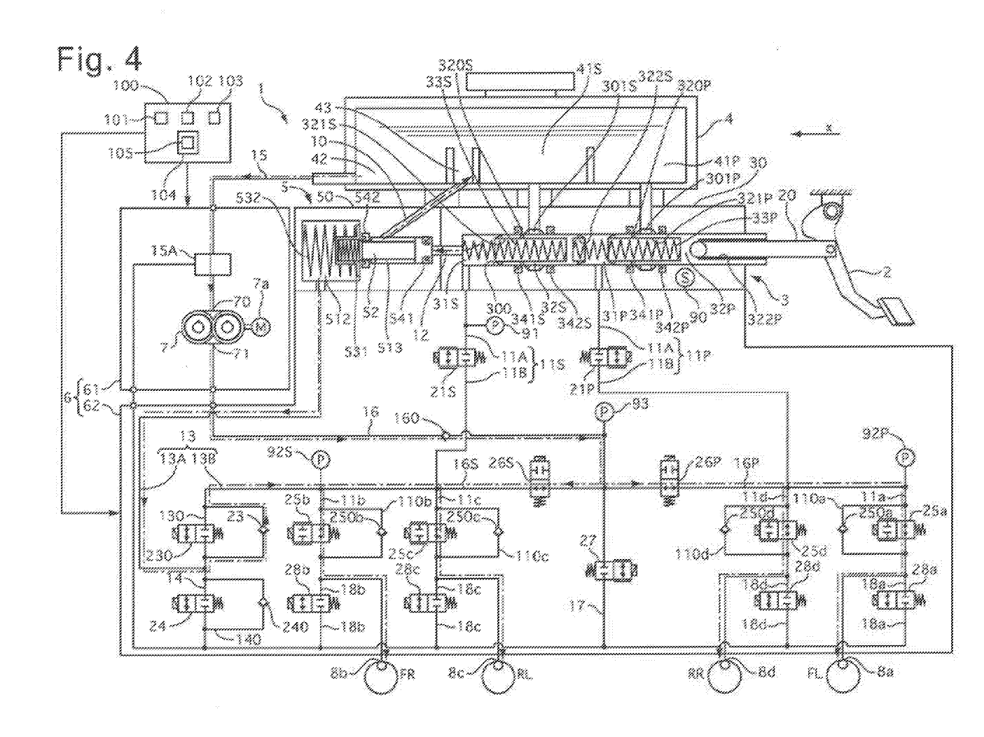

FIG. 4 illustrates an activation state of the brake apparatus 1 according to the first embodiment at the time of assist pressure increase control.

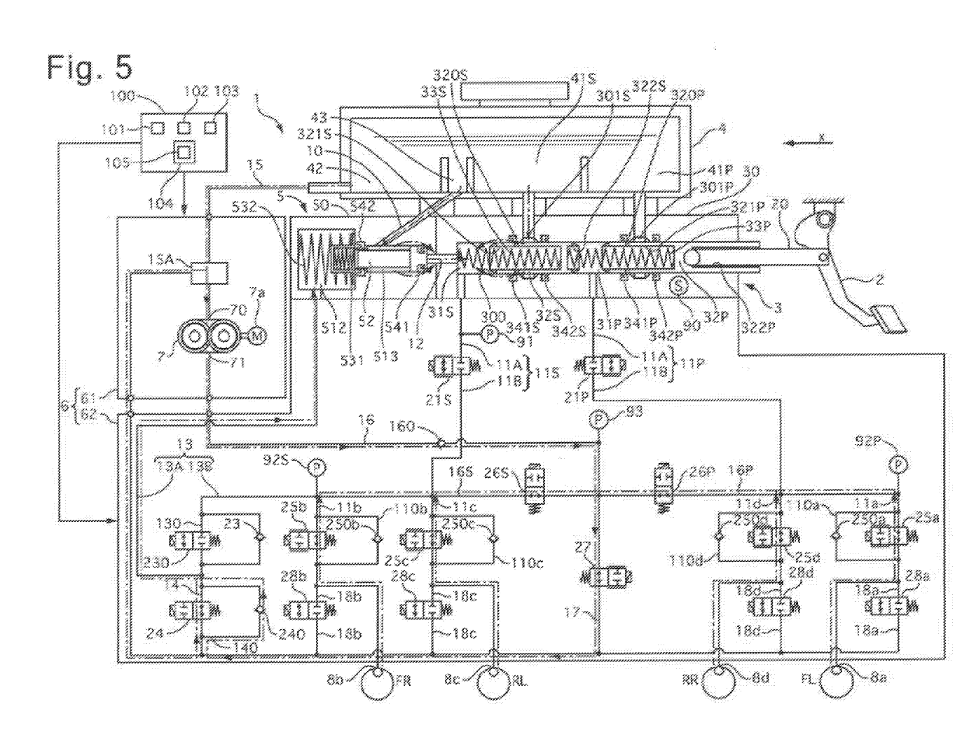

FIG. 5 illustrates an activation state of the brake apparatus 1 according to the first embodiment when an operation of returning the pedal is performed while the wheel cylinder pressure increase control is in operation.

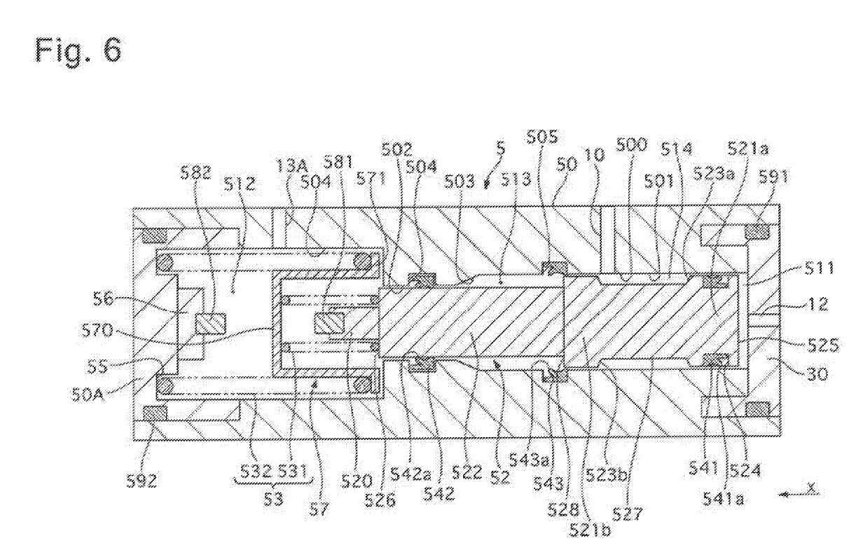

FIG. 6 schematically illustrates a configuration of the stroke simulator 5 according to a second embodiment.

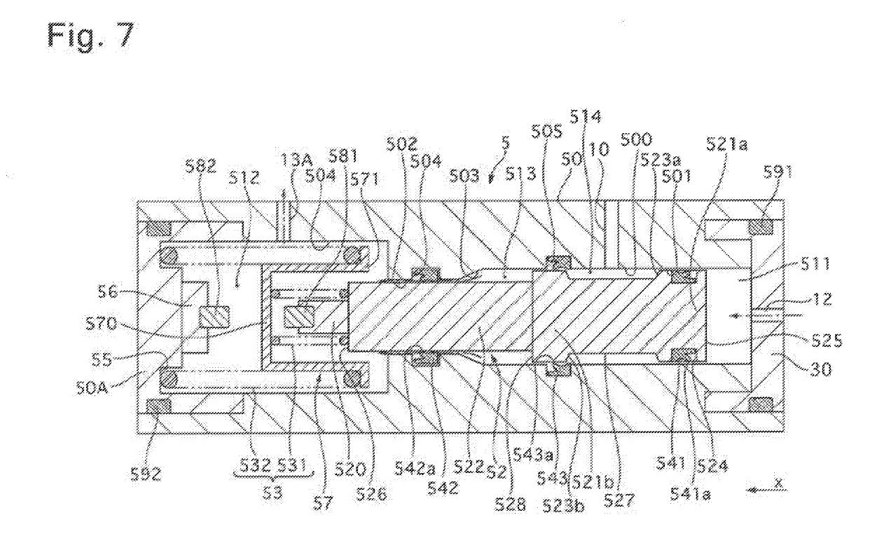

FIG. 7 illustrates a flow of brake fluid when a third piston seal 543 exerts a seal function in the stroke simulator 5 according to the second embodiment.

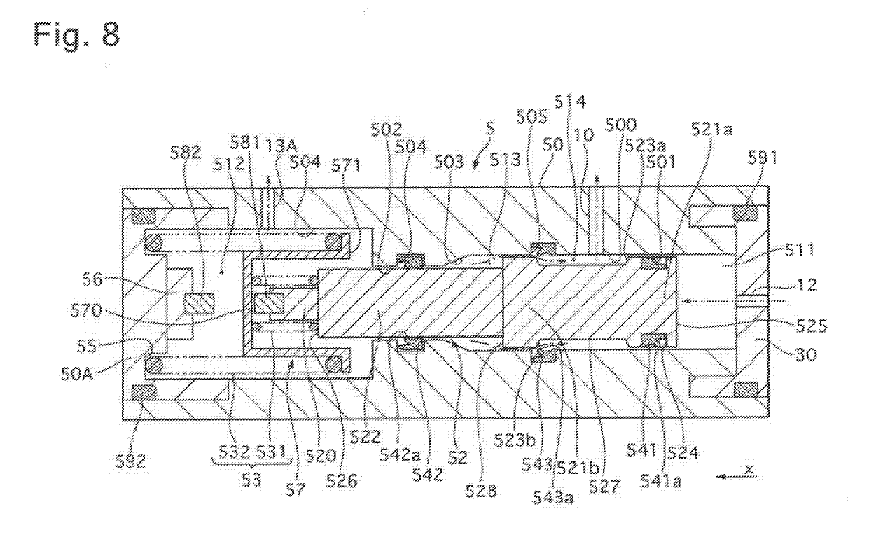

FIG. 8 illustrates a flow of the brake fluid when the third piston seal 543 stops exerting the seal function in the stroke simulator 5 according to the second embodiment.

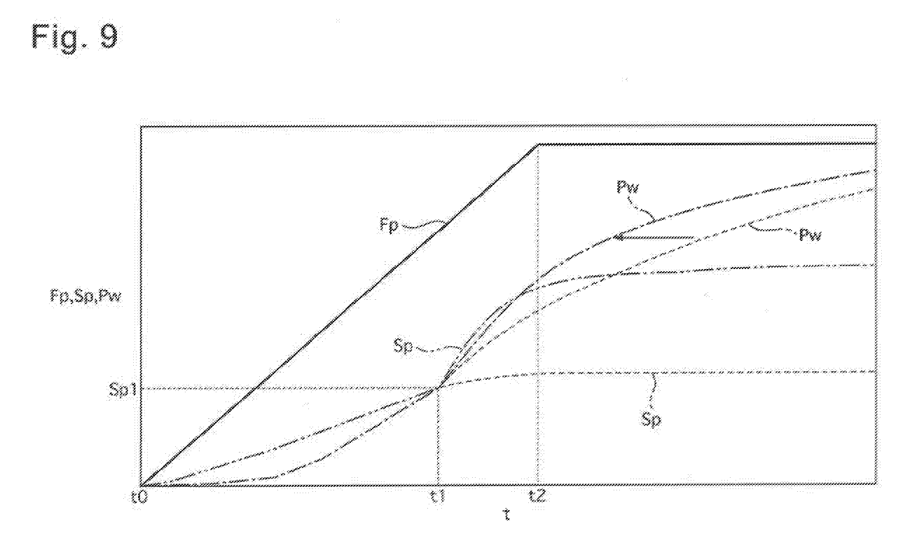

FIG. 9 is a timing chart illustrating changes in a wheel cylinder hydraulic pressure Pw and a pedal stroke Sp when the brake apparatus 1 performs the assist pressure increase control according to the second embodiment.

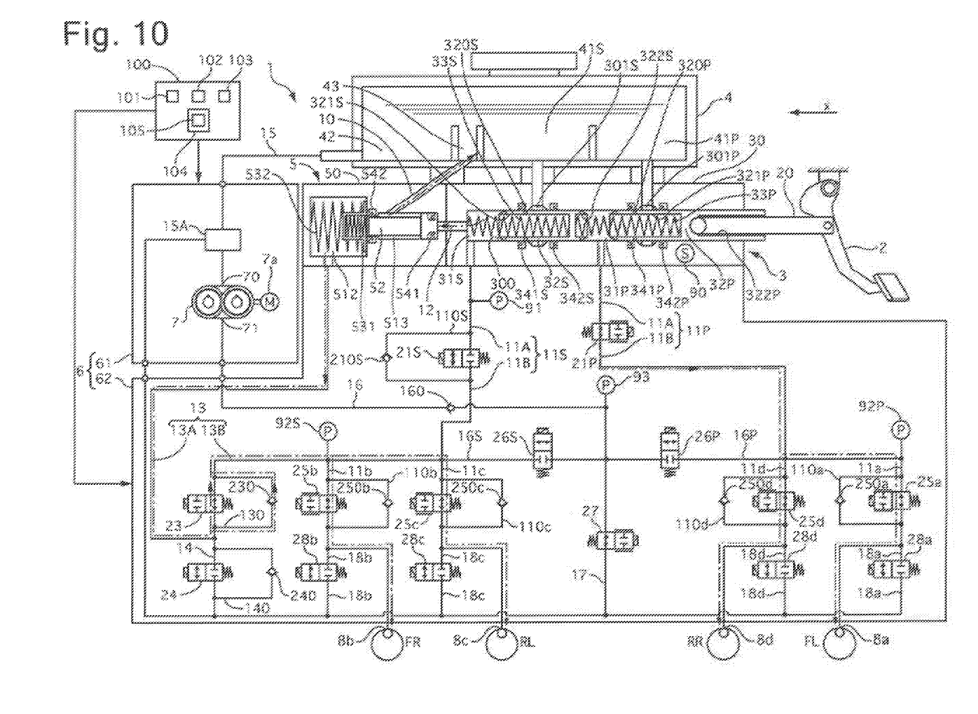

FIG. 10 schematically illustrates a configuration of the brake system according to a third embodiment.

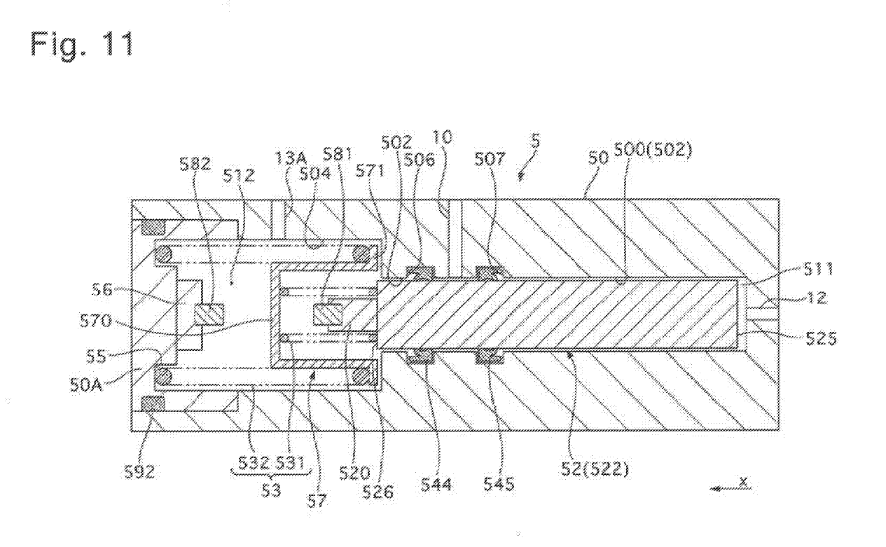

FIG. 11 schematically illustrates a configuration of the stroke simulator 5 according to a comparative example.

### DESCRIPTION OF EMBODIMENTS

In the following description, aspects for realizing a brake apparatus according to the present invention will be described based on embodiments illustrated in the drawings.

### First Embodiment

Configuration

First, a configuration will be described. FIG. 1 schematically illustrates a configuration of a brake system according to a first embodiment including a hydraulic circuit. The brake system includes a brake apparatus 1 (hereinafter referred to as an apparatus 1), a brake pedal 2, and a master cylinder 3. The brake system includes two brake pipe systems, i.e., a P (primary) system and an S (secondary) system, and employs, for example, an X-split pipe configuration. The apparatus 1 may employ another pipe configuration, such as a front/rear split pipe configuration. Hereinafter, when a member provided in correspondence with the P system find a member provided in correspondence with the S system should be distinguished from each other, indices P and S will be added at the ends of the respective reference numerals.

The brake pedal 2 is a brake operation member that receives an input of a brake operation from an operator (a driver). One end of a push rod 20 is rotatably connected to a base side of the brake pedal 2. The master cylinder 3 generates a brake hydraulic pressure (a master cylinder hydraulic pressure Pm) by being activated by an operation performed on the brake pedal 2 by the driver (the brake operation). The brake system does not include a negative-pressure booster that boosts or amplifies a brake operation force (a force Fp pressing the brake pedal 2) by utilizing an intake negative pressure generated by an engine of a vehicle. The master cylinder 3 is connected to the brake pedal 2 via the push rod 20, and is also replenished with the brake fluid from a reservoir tank (a reservoir) 4. The reservoir tank 4 is a brake fluid source that stores the brake fluid therein, and is a low pressure portion opened to an atmospheric pressure. A bottom portion side inside the reservoir tank 4 (a vertically lower side) is partitioned (divided) into a primary hydraulic chamber space 41P, a secondary hydraulic chamber space 41S, a fluid pool space 42, and a stroke simulator space 43 by a plurality of partition members each having a predetermined height. The master cylinder 3 is a tandem-type master cylinder, and includes a primary piston 32P and a secondary piston 32S in series as master cylinder pistons axially displaceable according to the brake operation. The primary piston 32P is connected to the push rod 20. The secondary piston 32S is configured as a free piston. A stroke sensor 90 is provided to the master cylinder 3. The stroke sensor 90 detects an amount of the axial displacement of the primary piston 32P. The amount of the axial displacement of the primary piston 32P corresponds to an amount of a displacement of the brake pedal 2 (a pedal stroke Sp). The apparatus 1 may be configured to detect Sp by providing the stroke sensor 90 to the push rod 20 or the brake pedal 2.

The apparatus 1 is a hydraulic brake apparatus suitable for an electric vehicle. Examples of the electric vehicle include a hybrid automobile including a motor generator (a rotational electric machine) in addition to an engine (an internal combustion engine), and an electric automobile including only the motor generator, as a prime mover for driving wheels. The apparatus 1 may also be applied to a vehicle using only the engine as the driving force source. The apparatus 1 supplies the brake fluid into a wheel cylinder 8 provided for each or wheels FL to RR of the vehicle, thereby generating a brake hydraulic pressure (a wheel cylinder hydraulic pressure Pw). The apparatus 1 displaces a fictional member by this hydraulic pressure Pw to press the frictional member against a rotational member on a wheel side, thereby generating a frictional force. By this operation, the apparatus 1 provides a hydraulic braking force to each of the wheels FL to PR. The wheel cylinder 8 may be a cylinder of a hydraulic brake caliper in a disk brake mechanism, besides a wheel cylinder in a drum brake mechanism. The apparatus 1 includes a stroke simulator 5, a hydraulic control unit C, and an electronic control unit 100. The stroke simulator 5 is a fluid absorption device that is activated according to the brake operation performed by the driver and absorbers the brake fluid therein. The stroke simulator 5 generates the pedal stroke Sp by an inflow of the brake fluid flowing out from inside the master cylinder 3 according to the brake operation performed by the driver into the stroke simulator 5. A piston 52 in the stroke simulator 5 is axially activated in a cylinder 50 due to the brake fluid supplied from the master cylinder 3. By this operation, the stroke simulator 5 generates an operation reaction force according to the brake operation performed by the driver.

The hydraulic control unit 6 is a braking control unit capable of generating the brake hydraulic pressure independently of the brake operation performed by the driver. The electronic control unit (hereinafter referred to as the ECU) 100 is a control unit that controls activation of the hydraulic control unit 6. The hydraulic control unit 6 receives the supply of the brake fluid from the reservoir tank 4 or the master cylinder 3. The hydraulic control unit 6 is provided between the wheel cylinders 8 and the master cylinder 3, and can supply the master cylinder hydraulic pressure Pm or a control hydraulic pressure to each of the wheel cylinders 8 individually. The hydraulic control unit 6 includes a motor 7a of a pump 7 and a plurality of control valves (electromagnetic valves 21 and the like) as hydraulic devices (actuators) for generating the control hydraulic pressure. The pump 7 introduces the brake fluid therein from a brake fluid source other than the master cylinder 3 (for example, the reservoir tank 4), and discharges the brake fluid toward the wheel cylinders 8. In the present embodiment, the pump 7 is embodied with use of a gear pump excellent in terms of a noise and vibration performance and the like, in particular, an external gear-type pump unit. A plunger pump or the like may be used as the pump 7. The pump 7 is used in common by both the systems, and is rotationally driven by the electric motor (a rotational electric machine) 7a as a common driving source. The motor 7a can be embodied with use of, for example, a brushed motor. A resolver is mounted on an output shaft of the motor 7a, and the resolver detects a rotational position (a rotational angle) thereof. The electromagnetic valves 21 and the like each performs an opening/closing operation according to a control signal to switch communication states of oil passages 11 or the like, thereby controlling a flow of the brake fluid. The hydraulic control unit 6 is provided so as to be able to increase the pressures in the wheel cylinders 8 with use of the hydraulic pressure generated by the pump 7 with the master cylinder 3 and the wheel cylinders 8 out of communication with each other. The hydraulic control unit 6 includes hydraulic sensors 91 to 93, which detect hydraulic pressures at various locations such as a discharge pressure of the pump 7 and Pm.

Detected values transmitted from the resolver, the stroke sensor 90, and the hydraulic sensors 91 to 93, and information regarding a running state transmitted from the vehicle side are input to the ECU 100. The ECU 100 performs information processing based on these various kinds of information according to a program installed therein. Further, the ECU 100 outputs an instruction signal to each of the actuators in the hydraulic control unit 6 according to a result of this processing, thereby controlling them. More specifically, the ECU 100 controls the opening/closing operations of the electromagnetic valves 21 and the like, and the number of rotations of the motor 7a (i.e., an amount discharged from the pump 7). By this control, the ECU 100 controls the wheel cylinder hydraulic pressure Pw at each of the wheels FL to RR, thereby realizing various kinds of brake control. For example, the ECU 100 realizes boosting control, anti-lock control, brake control for controlling a motion of the vehicle, automatic brake control, regenerative cooperative brake control, and the like. The boosting control assists the brake operation by generating the hydraulic braking force to cover insufficiency from the brake operation force input by the driver. The anti-lock control prevents or reduces a slip (a lock tendency) of any of the wheels FL to RR that is caused from the braking. The vehicle motion control is electronic stability control (hereinafter referred to as ESC) that prevents a sideslip and the like. The automatic brake control is adaptive cruise control of the like. The regenerative cooperative brake control controls Pw so as to achieve a target deceleration (a target braking force) by collaborating with the regenerative brake.

Hereinafter, an x axis is set to a direction in which a central axis of a cylinder 30 of the master cylinder 3 extends for convenience of the description. Assume that a positive-direction side of the x axis is one side where the secondary piston 32S is positioned with respect to the primary piston 32P. The master cylinder 3 is connected to the wheel cylinders 8 via first oil passages 11, which will be described below. The master cylinder 3 is a first hydraulic source capable of generating the hydraulic pressure Pw in each of the wheel cylinders 8 by generating a hydraulic pressure in the first oil passages 11 with use of the brake fluid supplied front the reservoir tank 4. The master cylinder 3 can increase the pressures in the wheel cylinders 8a and 8d via an oil passage (a first oil passage 11P) of the P system with use of the master cylinder hydraulic pressure Pm generated in a primary hydraulic chamber 31P. Further, the master cylinder 3 can also increase the pressures in the wheel cylinders 8b and 8c via an oil passage (a first oil passage 11S) of the S system with use of Pm generated in a second hydraulic chamber 31S. The pistons 32 of the master cylinder 3 are inserted in the bottomed cylindrical cylinder 30 displaceably in the x-axis direction along an inner peripheral surface 300 of a cylindrical shape thereof. The cylinder 30 includes a replenishment port 301 for each of the P and S systems. The replenishment ports 301 are connected to the reservoir tank A to be communicated therewith. The replenishment port 301P is connected to the primary hydraulic chamber space 41P, and the replenishment port 301S is connected to the secondary hydraulic chamber space 41S.

A coil spring 33P as a return spring is loaded, in a pressed and compressed state, in the primary hydraulic chamber 31P between both the pistons 32P and 32S. A coil spring 33S as a return spring is loaded, in a pressed and compressed state, in the secondary hydraulic chamber 31S between the piston 32S and an end of the cylinder 30 in the x-axis positive direction. Each of the pistons 32 includes recessed portions 321 and 322 extending in the x-axis direction. The recessed portion 321 is opened on an x-axis positive-direction side of the piston 32. The recessed portion 322 is opened on an x-axis negative-direction side of the piston 32. Focusing on the primary piston 32P, an x-axis negative-direction side of the coil spring 33P is placed in the recessed portion 321P. An x-axis positive-direction side of the push rod 20 is placed in the recessed portion 322P. Focusing on the secondary piston 32S, an x-axis negative-direction side of the coil spring 33S is placed in the recessed portion 321S. An x-axis positive-direction side of the coil spring 33P is placed in the recessed portion 322S. As oil hole 320 is formed so as to penetrate through the piston 32 on the x-axis positive-direction side of each of the pistons 32. The oil hole 320 establishes communication between an inner peripheral surface of the recessed portion 321 and an outer peripheral surface of the piston 32. The first oil passage 11 is constantly opened to each of the hydraulic chambers 31P and 31S. Each of the hydraulic chambers 31P and 31S is provided so as to be connectable to the hydraulic control unit 6 via the first oil passage 11 and communicable with the wheel cylinders 8. A second oil passage 12, which will be described below, is provided at an end of the cylinder 30 on the x-axis positive-direction side so as to extend in the x-axis direction. An end of the second oil passage 12 on the x-axis negative-direction side is constantly opened to the secondary hydraulic chamber 31S. The secondary hydraulic chamber 31S is connected to the stroke simulator 5 via the second oil passage 12.

Piston seals 34 (corresponding to 341 and 342 in the drawings) are disposed on the inner peripheral surface 300 of the cylinder 30. The piston seals 34 seal between the outer peripheral surfaces of the individual pistons 32P and 32S and the inner peripheral surface of the cylinder 30 while being in sliding contact with the individual pistons 32P and 32S (moving while contacting the individual pistons 32F and 32S). Each of the piston seals 34 is a well-known seal member (a cup seal) cup-shaped in cross-section that includes a lip portion on a radially inner side. The piston seal 34 permits a flow of the brake fluid in one direction, and prohibits or reduces a flow of the brake fluid in the other direction. Communication between the replenish port 301 and the hydraulic chamber 31 via the oil hole 320 is blocked in such a state that an opening portion of the oil hole 320 on the outer peripheral surface of the piston 32 is located on the z-axis positive-direction side with respect to the first piston seal 341 (the lip portion thereof). The first piston seal 341 permits a flow of the brake fluid heading from the replenishment port 301 toward the hydraulic chamber 31, and prohibits or reduces a flow of the brake fluid in an opposite direction therefrom, between the inner peripheral surface 300 of the cylinder 30 and the outer peripheral surface of the piston 32. The second piston seal 342P prohibits or reduces a flow of the brake fluid heading from the replenishment port 301P toward the brake pedal 2 side. The second piston seal 342S prohibits or reduces a flow of the brake fluid heading from the primary hydraulic chamber 31P toward the replenishment port 301S. When the piston 32 is stroked toward the x-axis positive-direction side by the driver's operation of pressing the brake pedal 2 to cause the above-described opening portion of the oil hole 320 to be located on the x-axis positive-direction side with respect to the first piston seal 314 (the lip portion thereof), the hydraulic pressure Pm is generated according to a reduction in the volume of the hydraulic chamber 31. As a result, the brake fluid is supplied from the hydraulic chamber 31 toward the wheel cylinders 8 via the first oil passages 11. Generally equal hydraulic pressures are generated in both the hydraulic chambers 81P and 31S.

The stroke simulator 5 includes the cylinder 50, a piston 52, and a spring 53. The stroke simulator 5 is provided integrally with the master cylinder 3. In other words, the master cylinder 3 and the stroke simulator 5 are provided in a same housing (formed by the cylinders 30 and 50), and forms a single master cylinder unit. The reservoir tank 4 is integrally installed in this master cylinder unit. FIG. 2 is a cross-sectional view taken along a central axis of the cylinder 50 of the stroke simulator 5, and schematically illustrates a configuration of the stroke simulator 5. The cylinder 50 is cylindrical, and is disposed on the x-axis positive-direction side of the master cylinder 3 in such a manner that the central axis thereof extends in the x-axis direction. For example, the cylinder 50 can be provided in such a manner that the end of the cylinder 30 of the master cylinder 3 on the x-axis positive-direction side is fitted in an opening portion of the cylinder 50 on the x-axis negative-direction side. A seal member 591 seals between the cylinders 30 and 50. An end of the second oil passage 12 provided at the cylinder 30 on the x-axis positive-direction side is constantly opened to an inner peripheral side of the cylinder 50. The inner peripheral surface 500 of the cylinder 50 is cylindrical. The cylinder 50 is disposed in such a manner that a central axis of the inner peripheral surface 500 is arranged on a generally same line as a central axis of the inner peripheral surface 300 of the cylinder 3. The second oil passage 12 is disposed so as to extend in the x-axis direction on the central axis of the inner peripheral surfaces 300 and 500. A cover member 50A is fitted in the opening portion of the cylinder 50 or the x-axis positive-direction side. As a result, the cylinder 50 has a bottomed cylindrical shape. The cover member 50A has a bottomed cylindrical shape; with an opening formed at an end thereof on the x-axis negative-direction side. A stopper portion 56 is provided at a center of an x-axis negative-direction side or a bottom portion of the cover member 50A. The stopper portion 56 has a stepped shape protruding toward the x-axis negative-direction side. A rubber 582 as an elastic member is placed at a distal end of the stopper portion 56 on the x-axis negative-direction side. A recessed portion 55 is provided at an end of the bottom portion of the cover member 50A on the x-axis negative-direction side. The recessed portion 55 surrounds the stopper portion 56. A seal member 532 seals between the cylinder 50 and the cover member 50A.

The cylinder 50 includes a piston containing portion on the x-axis negative-direction side, and a spring containing portion on the x-axis positive-direction side. An inner peripheral surface of the piston containing portion includes a large-diameter portion 501, a small-diameter portion 502, and a tapered portion 503. The large-diameter portion 501 is a relatively large-diameter inner peripheral surface provided on an x-axis negative-direction side of the piston containing portion. The small-diameter portion 502 is a relatively small-diameter inner peripheral surface provided on an x-axis positive-direction side of the piston containing portion. The tapered portion 503 is a tapered surface provided between the large-diameter portion 501 and the small-diameter portion 502 continuously therefrom. The capered portion 503 has a diameter gradually increasing as extending from the x-axis positive-direction side to the x-axis negative-direction side. A groove 504 extending in a direction around the central axis (hereinafter referred to a circumferential direction) is provided at the small-diameter portion 502. A communication oil passage 10 is provided at the cylinder 50. One end of the communication oil passage 10 is constantly opened to an x-axis positive-direction side of the large-diameter portion 501. The other end of the communication oil passage 10 is connected to the stroke simulator space 43 of the reservoir tank 4. An inner peripheral surface 504 of the spring containing portion is an inner peripheral surface larger in diameter than the large-diameter portion 501 that is continuously provided on the x-axis positive-direction side of the small-diameter portion 502. A third oil passage 13 (13A), which will be described below, is constantly opened to the inner peripheral surface 504.

The piston 52 is mounted displaceably in the x-axis direction in the cylinder 50 along the inner peripheral surface 500 of the cylinder 50. The piston 52 and the piston 32 of the master cylinder 3 are disposed on a generally same central axis. The piston 52 is a stepped piston. The piston 52 includes a stopper portion 520, a large-diameter portion 521, a small-diameter portion 522, and a tapered portion 523. The large-diameter portion 521 is a cylindrical portion relatively large in diameter that is provided on an x-axis negative-direction side of the piston 52. The small-diameter portion 522 is a cylindrical portion relatively small in diameter that is provided on an x-axis positive-direction side of the piston 52. The tapered portion 523 is provided between the large-diameter portion 521 and the small-diameter portion 522 continuously therefrom. The tapered portion 523 has a diameter gradually increasing as extending from the x-axis positive-direction side toward the x-axis negative-direction side. The stopper portion 520 is a cylindrical portion smaller in diameter than the small-diameter portion 522 that is provided so as to protrude from a surface of the small-diameter, portion 522 on the x-axis positive-direction side toward the x-axis positive-direction side. A rubber 531 as an elastic member is placed on an end surface of the stopper portion 520 on the x-axis positive-direction side. A circumferentially extending groove 524 is provided on an outer peripheral surface of the large-diameter portion 521. A diameter of the large-diameter portion 521 is slightly smaller than the diameter of the large-diameter portion 501 of the cylinder 50. A diameter of the small-diameter portion 522 is slightly smaller than the diameter of the small-diameter portion 502 of the cylinder 50. A dimension of the large-diameter portion 521 in the x-axis direction is shorter than a dimension of the large-diameter portion 501 in the x-axis direction. The large-diameter portion 523 is disposed on an inner peripheral side of the large-diameter portion 501, and the small-diameter portion 522 is disposed on an inner peripheral side of the small-diameter portion 502.

The piston 52 is a separation member (a partition wall) that divides the inside of the cylinder 50 into at least two chambers (a positive pressure chamber 511 and a backpressure chamber 512). In the cylinder 50, the positive pressure chamber 511 and the backpressure chamber 512 are defined on an x-axis negative-direction side and an x-axis positive-direction side of the piston 52, respectively. The positive pressure chamber 511 is a space mainly surrounded by a surface 525 of the large-diameter portion 521 of the piston 52 on the x-axis negative-direction side, the large-diameter portion 501 of the cylinder 50, and a surface of the cylinder 30 on the x-axis positive-direction side (where the second oil passage 12 is opened). The second oil passage 12 is constantly opened to the positive pressure chamber 511. The backpressure chamber 512 is a space mainly surrounded by a surface 526 of the stopper portion 520 and the small-diameter portion 522 of the piston 52 (including the rubber 581) on the x-axis positive-direction aids (i.e., a surface when these portions 520 and 522 are viewed from the x-axis positive-direction side), the inner peripheral surface 504 of the cylinder 50, and a surface of the cover member 50A on the x-axis negative-direction side. The oil passage 13A is constantly opened to the backpressure chamber 512.

The surface 525 of the large-diameter portion 521 of the piston 52 faces the positive pressure chamber 511 and is a first pressure-receiving surface that receives a pressure of the brake fluid in the positive pressure chamber 511. A diameter of the surface 525 (a first pressure-receiving diameter) is equal to the diameter of the large-diameter portion 521. An area (a first pressure-receiving area) A1 of the surface 525 is equal to a cross-sectional area of the large-diameter portion 521 in a direction orthogonal to the axis. The surface 526 of the piston 52 (including the rubber 581) at the stopper portion 520 and the small-diameter portion 522 faces the backpressure chamber 512, and is a second pressure-receiving surface that receives a pressure of the brake fluid in the backpressure chamber 512. A diameter of the surface 526 (a second pressure-receiving diameter) is equal to the diameter of the small-diameter portion 522 but is smaller than the diameter of the surface 525 (the first pressure-receiving diameter). An area (a second pressure-receiving area) A2 of the surface 526 is equal to the cross-sectional area of the small-diameter portion 522 in the direction orthogonal to the axis but is smaller than the area (the first pressure-receiving area) A1 of the surface 525. A space surrounded by the large-diameter portion 501 and the tapered portion 503 of the cylinder 50 and outer peripheral surfaces of the small-diameter portion 522 and the tapered portion 523 of the piston 52 is a volume variable chamber 513, a volume of which varies according to a displacement of the piston 52 relative to the cylinder 50 in the x-axis direction. The communication oil passage 10 is constantly opened to the volume variable chamber 513 in a range where the piston 52 is displaceable relative to the cylinder 50 in the x-axis direction/without being covered by the outer peripheral surface of the piston 52 (the large-diameter portion 521).

A first piston seal 541 is placed in the groove 524 of the piston 52 (the large-diameter portion 521). The first piston seal 541 is in sliding contact with the inner peripheral surface (the large-diameter portion 501) of the cylinder 50, and seals between the large-diameter portion 501 and the outer peripheral surface of the piston 52 (the large-diameter portion 521). A second piston seal 542 is placed in the groove 504 of the cylinder 50 (the small-diameter portion 502). The second piston seal 542 is in sliding contact with the small-diameter portion 522 of the piston 52, and seals between the outer peripheral surface of the small-diameter portion 522 and the inner peripheral surface of the cylinder 50 (the small-diameter portion 502). Both the piston seals 541 and 542 are separation seal members that seal between the positive pressure chamber 511 and the backpressure chamber 512 to thereby liquid-tightly separate them, and complement the function of the piston 52 as the above-described separation member. Each of the piston seals 541 and 542 is a well-known seal member cup-shaped in cross section (a cup seal). The first piston seal 541 includes a lip portion 541a on a radially outer side thereof, and the second piston seal 542 includes a lip portion 542a on a radially inner side thereof. The first piston seal 541 (the lip portion 541a) permits a flow of the brake fluid heading from the volume variable chamber 513 toward the positive pressure chamber 511, and prohibits or reduces a flow of the brake fluid in an opposite direction therefrom. The second piston seal 542 (the lip portion 542a) permits a flow of the brake fluid heading from the volume variable chamber 513 toward the backpressure chamber 512, and prohibits to reduces a flow of the brake fluid in an opposite direction therefrom. The communication oil passage 10 establishes communication of a region sandwiched between the first piston seal 541 and the second piston seal 542 in the cylinder 50 (including the volume variable chamber 513) with the reservoir tank 4.

The spring 53 is a coil spring (an elastic member) placed in a pressed and compressed state in the backpressure chamber 512, and constantly biases the piston 52 toward the x-axis negative-direction side. The spring 53 is provided deformably in the x-axis direction, and can generate a reaction force according to the displacement amount (the stroke amount Sss) of the piston 52. The spring 53 includes a first spring 531 and a second spring 532. The first spring 531 is shorter in diameter and dimension than the second spring 532, and has a short wire diameter. A spring constant of the first spring 531 is smaller than that of the second spring 532. The first and second springs 531 and 532 are disposed in series between the piston 52 and the cylinder 50 (the cover member 50A) via a retainer member 57. The retainer member 57 has a bottomed cylindrical shape, and includes a flange portion 571 at an opening portion thereof. An end of the first spring 531 on the x-axis negative-direction side is disposed on a surface of the small-diameter portion 522 of the piston 52 on the x-axis positive-direction side. An end of the first spring 531 on the x-axis positive-direction side is disposed on a surface of a bottom portion 570 of the retainer member 57 on the x-axis negative-direction side. An end of the second spring 532 on the x-axis negative-direction side is disposed on a surface of the flange portion 571 of the retainer member 57 on the x-axis positive-direction side. An end of the second spring 532 on the x-axis positive-direction side is disposed on a bottom surface of the recessed portion 55 of the cover member 50A.

Next, a hydraulic circuit of the hydraulic control unit 6 will be described with reference to FIG. 1. Members corresponding to the individual wheels FL to RR will be distinguished from one another if necessary, by indices a to d added at the ends of reference numerals thereof, respectively. The first oil passages 11 connect the hydraulic chambers 81 of the master cylinder 3 and the wheel cylinders 8. A shut-off valve (a master cut valve) 21 is a normally-opened (opened when no power is supplied) electromagnetic valve provided in each of the first oil passages 11. Each of the first oil passages 11 is divided into an oil passage 11A on a master cylinder 3 side and an oil passage 11B on a wheel cylinder 8 side by the shut-off valve 21. A solenoid IN valve (a pressure increase valve) SOL/V IN 25 is a normally-opened electromagnetic valve provided in correspondence with each of the wheels FL to RR (in each of oil passages 11a to 11d) on the wheel cylinder 8 side (in the oil passage 11B) with respect to the shut-off valve 21 in the first oil passage 11. A bypass oil passage 110 is provided in parallel with the first oil passage 11 while bypassing the SOL/V IN 25. A check valve (a one-way valve or a non-return valve) 250 is provided in the bypass oil passage 11C. The check valve 250 permits only a flow of the brake fluid from the wheel cylinder B side to the master cylinder 3 side.

An intake oil passage 15 is an oil passage that connects the reservoir tank A (the fluid pool space 42) and an intake portion 70 of the pump 7, and functions as a low pressure portion. A discharge oil passage 16 connects a discharge portion 71 of the pump 7 and a portion in the first oil passage 11B between the shut-off valve 21 and the SOL/V IN 25. A check valve 160 is provided in the discharge oil passage 16, and permits only a flow of the brake fluid from one side where the discharge portion 71 of the pump 7 is located (an upstream side) to the other side where the first oil passage 11 is located (a downstream side). The check, valve 160 is a discharge valve (a first one-way valve) provided to the pump 7. The discharge oil passage 16 branches into an oil passage 36P of the P system and an oil passage 16S of the S system or the downstream side of the check valve 160. The individual oil passages 16P and 16S are connected to the first oil passage 11P of the P system and the first oil passage 11S of the S system, respectively. The oil passages 16P and 16S function as a communication passage that connects the first oil passages 11P and 11S to each other. A communication valve 26P is a normally-closed (closed when no power is supplied) electromagnetic valve provided in the discharge oil passage 16P. A communication valve 26S is a normally-closed electromagnetic valve provided in the oil passage 16S. The pump 7 is a second hydraulic source capable of generating the hydraulic pressure Pw in the wheel cylinders 8 by generating the hydraulic pressure in the first oil passages 11 with use of the brake fluid supplied from the reservoir tank 4 or the like. The pump 7 is connected to the wheel cylinders 8a to 8d via the above-described communication passages (the discharge oil passages 16P and 16S) and the first oil passages 11P and 11S, and can increase the pressures in the wheel cylinders 8 by discharging the brake fluid to the above-described communication passages (the discharge oil passages 16P and 16S).

A first pressure reduction oil passage 17 connects a portion in the discharge oil passage 16 between the check valve 160 and the communication valves 26, and the intake oil passage 15. A pressure adjustment valve 27 is a normally-opened electromagnetic valve as a first; pressure reduction valve provided in the first pressure reduction oil passage 17. The pressure adjustment valve 27 may be a normally-closed electromagnetic valve. A second pressure reduction oil passage 18 connects the wheel cylinder 8 side of the first oil passage 11B with respect to the SOL/IN 25, and the intake oil passage 15. A solenoid OUT valve (a pressure reduction valve) SOL/V OUT 28 is a normally-closed electromagnetic valve as a second pressure reduction valve provided in the second pressure reduction oil passage 18. In the present embodiment, the first pressure reduction oil passage 17 on one side closer to the intake oil passage 15 with respect to the pressure adjustment valve 27, and the second pressure reduction oil passage 18 on one side closer to the intake oil passage 15 with respect to the SOL/V OUT 28 share a part thereof with each other.

The second oil passage 12 is a positive pressure-side oil passage that extends, in the x-axis direction, through the bottom portion of the secondary hydraulic chamber 31S of the master cylinder 3 on the x-axis positive-direction side and connects the secondary hydraulic chamber 31S and the positive pressure chamber 511 of the stroke simulator 5. The third oil passage 13 is a first backpressure-side oil passage that connects the backpressure chamber 512 of the stroke simulator 5 and the first oil passage 11. More specifically, the third oil passage 13 branches off from a portion in the first oil passage 11S (the oil passage 11B) between the shut-off valve 21S and the SOL/V IN 25, and is connected to the backpressure chamber 512. A first stroke simulator IN valve SS/V IN 23 is a check valve provided in the third oil passage 13. The third oil passage 13 is divided into the oil passage 13A on the backpressure chamber 512 side and an oil passage 13B on the first oil passage 11 side by the first SS/V IN 23. The first SS/V IN 23 permits a flow of the brake fluid heading from the backpressure chamber 512 side (the oil passage 13A) toward the first oil passage 11 side (the oil passage 13B), and prohibits or reduces a flow of the brake fluid in an opposite direction therefrom. A bypass oil passage 130 is provided in parallel with the third oil passage 13 while bypassing the first SS/V IN 23. The bypass oil passage 130 connects the oil passage 13A and the oil passage 13B. A second stroke simulator IN valve SS/V IN 230 is a normally-closed electromagnetic valve provided in the bypass oil passage 130.

A fourth oil passage 14 is a second backpressure-side oil passage that connects the backpressure chamber 512 of the stroke simulator 5 and the reservoir tank 4. The fourth oil passage 14 is provided so as to permit both a flow of the brake fluid from the backpressure chamber 512 and a flow of the brake fluid from the reservoir tank 4. More specifically, the fourth oil passage 14 connects a portion in the third oil passage 13 between the backpressure chamber 512 and the first SS/V IN 23 (the oil passage 13A), and the intake oil passage 15 (or the first pressure reduction oil passage 17 on the intake oil passage 15 side with respect to the pressure adjustment valve 27, and the second pressure reduction oil passage 18 on the intake oil passage 15 side with respect to the SOL/V OUT 28). The fourth oil passage 14 may be directly connected to the backpressure chamber 512 or the reservoir tank 4. In the present embodiment, a part of the fourth oil passage 14 on the backpressure chamber 512 side is shared with the third oil passage 13A, and a part of the fourth oil passage 14 on the reservoir tank 4 side is shared with the intake oil passage 15 and the like, whereby the configuration of the oil passage can be simplified as a whole. A stroke simulator OUT valve (a simulator cut valve) SS/V OUT 24 is a normally-closed electromagnetic valve provided in the fourth oil passage 14. If the fourth oil passage 14 is interpreted as the oil passage directly connected to the backpressure chamber 512, the third oil passage 13 is interpreted as connecting a portion in the fourth oil passage 14 between the backpressure chamber 512 and the SS/V OUT 24, and the oil passage 11B. A bypass oil passage 140 is provided in parallel with the fourth oil passage 14 while bypassing the SS/V OUT 24. A check valve 240 is provided in the bypass oil passage 140. The check valve 240 permits a flow of the brake fluid heading from the reservoir tank 4 (the intake oil passage 15) side toward the third oil passage 13A side, i.e., the backpressure chamber 512 side, and prohibits or reduces a flow of the brake fluid in an opposite direction therefrom.

The shut-off valve 21, the SOL/V IN 25, and the pressure adjustment valve 27 are each a proportional control valve, an opening degree of which is adjusted according to a current supplied to a solenoid. The other valves, i.e., the second SS/V IN 230, the SS/V OUT 24, the communication valve 26, and the SOL/V OUT 28 are two-position (OK/OFF) valves, opening/closing of which is controlled to be switched between two values, i.e., switched to be either opened or closed. The above-described other valves can also be embodied with use of the proportional control valve. The hydraulic sensor 91 is provided in the first oil passage 11S between the shut-off valve 21S and the master cylinder 3 (the oil passage 11A). The hydraulic sensor 91 detects a hydraulic pressure at this portion (the master cylinder hydraulic pressure Pm and the hydraulic pressure in the positive pressure chamber 511 of the stroke simulator 5). The hydraulic sensor 91 may be provided in the second oil passage 12 or the oil passage 11A of the S system. The hydraulic sensor (a primary system pressure sensor or a secondary system pressure sensor) 92 is provided in the first oil passage 11 between the shut-off valve 21 and the SOL/V IN 25. The hydraulic senor 92 detects a hydraulic pressure at this portion (the wheel cylinder hydraulic pressure Pw). The hydraulic sensor 93 is provided in the discharge oil passage 16 between the discharge portion 71 of the pump 7 (the check valve 160) and the communication valve 26. The hydraulic senor 93 detects a hydraulic pressure at this portion (the pump discharge pressure). The hydraulic sensor 93 may be provided in the first pressure reduction oil passage 17 between a portion thereof connected to the discharge oil passage 16, and the pressure adjustment valve 27.

A fluid pool 15A having a predetermined volume is provided in the intake oil passage 15. The fluid pool 15A is an internal reservoir of the hydraulic control unit 6. The first, and second pressure reduction oil passages 17 and 18, and the fourth oil passage 14 are connected to the fluid pool 15A. The pump 7 introduces the brake fluid therein from the reservoir tank 4 via the fluid pool 15A. The brake fluid in the first and second pressure reduction oil passages 17 and 18, and the fourth oil passage 14 is returned to the reservoir tank 4 via the fluid pool 15A. The hydraulic control unit 6 includes a first unit 61 and a second unit 62. The first unit 61 is a pump unit that induces the pump 7 and the motor 7a. The second unit 62 is a valve unit that contains each of the valves 21 and the like. Further, the second unit 62 includes each of the sensors 90 to 93. The ECU 100 may be integrally mounted on the second unit 62. The first and second units 61 and 62 control each of the actuators according to the control instruction from the SCU 100. The first and second units 61 and 62 are configured separately, and are connected to each other via an external pipe. Both the units 61 and 62 are connected via an external pipe that forms the discharge oil passage 16 and an external pipe that forms the first pressure reduction oil passage 17 and the second pressure reduction oil passage 18.

The second unit 62 (the valve unit) is provided integrally with the master cylinder 3 and the stroke simulator 5 (a master cylinder unit), and they form a single unit as a whole. In other words, the master cylinder 3, the stroke simulator 5, the valves 21, and the like (including the cylinders 30 and 50) are provided in a same housing. Each of the oil passages of the second unit 62 and the master cylinder unit are connected directly without intervention of any external pipes. The master cylinder unit is disposed vertically above the second unit 62. The above-described integral unit including the second unit 62 and the like, and the first unit 61 are configured separately, and are connected to each other via an external pipe. These units are connected via, for example, an external pipe forming the intake oil passage 15. More specifically, the reservoir tank 4 in the master cylinder unit and the first unit 61 are connected via the above-described pipe. The fluid pool 15A is provided close to a portion inside the first unit 61 to which the above-described pipe forming the intake oil passage 15 is connected (vertically above the first unit 61).

A first system is formed by a brake system (the first oil passages 11) that connects the hydraulic chamber 31 of the master cylinder 3 and the wheel cylinders 8 with the shut-off valve 21 controlled in a valve-opening direction. This first system can realize pressing force brake (non-boosting control) by generating the wheel cylinder hydraulic pressure Pw from the master cylinder hydraulic pressure Pm generated with use of the pressing force Fp. On the other hand, a second system is fenced by a brake system (the intake oil passage 15, the discharge oil passage 16, and the like) that includes the pump 7 and connects the reservoir tank 4 (the fluid pool 15A) and the wheel cylinders 8 with the shut-off valve 21 controlled in a valve-closing direction. This second system constructs a so-called brake-by-wire device, which generates the wheel cylinder hydraulic pressure Pw from the hydraulic pressure generated with use of the pump 7, and can realize the boosting control and the like as the brake-by-wire control. At the time of the brake-by-wire control (hereinafter simply referred to as by-wire control), the stroke simulator 5 creates the operation reaction force according to the brake operation performed by the driver.

The ECU 100 includes a brake operation state detection unit 101, a target wheel cylinder hydraulic pressure calculation unit 102, a pressing force brake generation unit 103, and a wheel cylinder hydraulic control unit 104. The brake operation state detection unit 101 detects the pedal stroke Sp as the brake operation amount input by the driver upon receiving the input of the value detected by the stroke sensor 90. Further, the brake operation state detection unit 101 detects whether the driver is performing the brake operation (whether the brake pedal 2 is being operated) and also detects or estimates a speed of the brake operation performed by the driver, based on Sp. More specifically, the brake operation state detection unit 101 detects or estimates the brake operation speed by calculating a speed of a change in Sp (a pedal stroke speed ≢Sp/Δt). A pressing force sensor for detecting the pressing force Fp may be provided and the brake operation amount may be detected or estimated based on a vale detected thereby. Alternatively, the brake operation state detection unit 101 may be configured to detect or estimate the brake operation amount based on the value detected by the hydraulic sensor 91. In other words, the brake operation state detection unit 101 way use, instead of Sp, another appropriate variable as the brake operation amount to be used in the control.

The target wheel cylinder hydraulic pressure calculation unit 102 calculates a target wheel cylinder hydraulic pressure Pw*. For example, at the time of the boosting control, the target wheel cylinder hydraulic pressure calculation unit 102 calculates, based on detected Sp (the brake operation amount), Pw* that realizes an ideal relationship (a brake characteristic) between Sp and a brake hydraulic pressure requested by the driver (a vehicle deceleration requested by the driver) according to a predetermined boosting ratio. For example, a predetermined relationship between Sp and Fw (the braking force) realized when the negative-pressure booster is activated in a brake apparatus including a negative-pressure booster normal in size is set as the above-described ideal relationship for calculating Pw*. Further, at the time of the anti-lock control, the target wheel cylinder hydraulic pressure calculation unit 102 calculates Pw* of each of the wheels FL to RR so that each of the wheels FL to RR has an appropriate slip amount (an amount by which the speed of this wheel deviates from a simulated speed of a vehicle body). At the time of the ESC, the target wheel cylinder hydraulic pressure calculation unit 102 calculates, based on, for example, a detected amount of a vehicle notion state (a lateral acceleration and/or the like), Pw* of each of the wheels FL to RR so as to realize a desired vehicle motion state. At the time of the regenerative cooperative brake control, the target wheel cylinder hydraulic pressure calculation unit 102 calculates Pw* in relation to a regenerative braking force. For example, the target wheel cylinder hydraulic pressure calculation unit 102 calculates such Pw* that a sum of the regenerative braking force input from a control unit of a regenerative braking device aid a hydraulic braking force corresponding to the target wheel cylinder hydraulic pressure can satisfy the vehicle deceleration requested by the driver.

The pressing force brake generation unit 103 controls the shut-off valve 21 in the valve-opening direction, thereby bringing the hydraulic control unit 6 into a state capable of generating the wheel cylinder hydraulic pressure Pw from the master cylinder hydraulic pressure Pm (the first system), thus realizing the pressing force brake. At this time, the pressing force brake generation unit 103 controls the SS/V OUT 24 in a valve-closing direction, thereby making the stroke simulator 5 inactive in response to the brake operation performed by the driver. As a result, the brake fluid is efficiently supplied from the master cylinder 3 toward the wheel cylinders 8. Therefore, a reduction in Pw generated by the driver with use of Fp can be prevented or cut down. The pressing force brake generation unit 103 may be configured to control the second SS/V IN 230 in a valve-opening direction. The shut-off valve 21 is a constantly-opened valve. Therefore, when a power failure has occurred, the apparatus 1 can automatically realize the pressing force brake by allowing the shut-off valve 21 to be opened. The SS/V OUT 24 is a normally-closed valve. Therefore, when the power failure has occurred, the apparatus 1 automatically makes the stroke simulator 5 inactive by allowing the SS/V OUT 24 to be closed. The communication valve 26 is a normally-closed valve. Therefore, when the power failure has occurred, the apparatus 1 allows the brake hydraulic systems of the two systems to operate independently of each other, allowing both the systems to increase the pressure in the wheel cylinder with use of Fp separately from each other. Due to this configuration, the apparatus 1 can improve a fail-safe capability.

The wheel cylinder hydraulic control unit 104 controls the shut-off valve 21 in the valve-closing direction, thereby bringing the hydraulic control unit 6 into a state capable of generating Pw (pressure increase control) with use of the pump 7 (the second system). The wheel cylinder hydraulic control unit 104 controls each of the actuators in the hydraulic control unit 6 in this state, thereby performing hydraulic control (for example, the boosting control) for realizing Pw*. More specifically, the wheel cylinder hydraulic control unit 104 controls the shut-off valve 21 in the valve-closing direction, the communication valve 26 in a valve-opening direction, and the pressure adjustment valve 27 in a valve-closing direction, and also activates the pump 7. Controlling each of the actuators in this manner allows desired brake fluid to be transmitted from the reservoir tank 4 side to the wheel cylinder 8 via the intake oil passage 15, the pump 7, the discharge oil passage 16, and the first oil passage 11. At this time, a desired braking force can be acquired by performing feedback control on the number of rotations of the pump 7 and a valve-opening state (an opening degree and/or the like) of the pressure adjustment valve 27 so that the value detected by the hydraulic sensor 92 approaches Pw*. In other words, Pw can be adjusted by controlling the valve-opening state of the pressure adjustment valve 27 and allowing the brake fluid to leak from the discharge oil passage 16 or the first oil passage 11 to the intake oil passage 15 via the pressure adjustment valve 27 as appropriate. In the present embodiment, Pw is controlled basically by changing the valve-opening state of the pressure adjustment valve 27 instead of the number of rotations of the pump 7 (the motor 7a). For example, an instruction value Nm* for the number of rotations of the motor 7a is kept at a predetermined small constant value for generating a required minimum pump discharge pressure (supplying the pump discharge amount) while Fw is maintained or reduced, expect for being set to a predetermined large constant value while Pw is increased. In the present embodiment, the pressure adjustment valve 27 is configured as the proportional control valve, which makes fine control possible, thereby allowing realization of smooth control of Pw. Controlling the shut-off valve 21 in the valve-closing direction and blocking the communication between the master cylinder 3 side and the wheel cylinder 8 side facilitate the control of Pw independent of the brake operation performed by the driver.

The wheel cylinder hydraulic control unit 104 basically performs the boosting control at the time of normal brake, in which the braking force is generated on the front and rear wheels FL to RR according to the brake operation performed by the driver. The wheel cylinder hydraulic control unit 104 controls the SOL/V IN 25 in a valve-opening direction and the SOL/V OUT 28 in a valve-closing direction for each of the wheel FL to PR at the time of the normal boosting control. The wheel cylinder hydraulic control unit 104 controls the pressure adjustment valve 27 in the valve-closing direction (performs the feedback control on the opening degree and/or the like) with the shut-off valves 21P and 21S controlled in the valve-closing directions. The wheel cylinder hydraulic control unit 104 controls the communication valve 26 in the valve-opening direction, and activates the pump 7 while setting the instruction value Nm* for the number of rotations of the motor 7a to a predetermined constant value. The wheel cylinder hydraulic control unit 104 deactivates the second SS/V IN 230 (controls the second SS/V IN 230 in the valve-closing direction), and activates the SS/V OUT 24 in a valve-opening direction (controls the SS/V OUT 24 in the valve-opening direction).

The wheel cylinder hydraulic control unit 104 includes an assist pressure increase control unit 105. The assist pressure increase control supplies the brake fluid flowing out of the backpressure chamber 512 off the stroke simulator 5 according to the brake operation performed by the driver to the wheel cylinder 8. The assist pressure increase control is control for assisting the generation of Pw using the pump 7 due to this supply, thus improving responsiveness of the increase in the pressure in the wheel cylinder 8. The assist pressure increase control is performed when the responsiveness of the increase in the pressure in the wheel cylinder 8 with use of the pump 7 becomes insufficient. In other words, the assist pressure increase control is positioned as spare (backup) control for wheel cylinder pressure increase control using the pump 7. The assist pressure increase control unit 105 performs the assist pressure increase control according to a state of the brake operation performed by the driver when increasing Pw at each of the wheels FL to RR (performing the wheel cylinder pressure increase control using the pump 7) according to the driver's operation of pressing the brake pedal 2 (the increase in the pedal stroke Sp) at the time of the boosting control (the normal brake) by the wheel cylinder, hydraulic; control unit 104. More specifically, the assist pressure increase control unit 105 deactivates the second SS/V IN 230 (controls the second SS/V IN 230 in the valve-closing direction) and deactivates the SS/V OUT 24 (controls the SS/V OUT 24 in the valve-closing direction). A content of control of the other actuators, such as activating the pump 7, is similar to the content at the time of the normal boosting control.

The assist pressure increase control unit 105, for example, determines whether the state of the brake operation performed by the driver is a predetermined sudden brake operation, and allows the assist pressure increase control to be performed if determining that the sudden brake operation is performed (the brake pedal 2 is pressed at a high speed). The assist pressure increase control unit 105 does not perform the assist pressure increase control if determining that the sudden brake operation is not performed (the brake pedal 2 is not pressed at a high speed). In other words, the responsiveness of the increase in the pressure in the wheel cylinder 8 with use of the pump 7 becomes noticeably insufficient when the sudden brake operation is performed, i.e., the brake operation is performed at a high speed to make it difficult to pump 7 to increase the pressure in the wheel cylinder 8 according to this high-speed brake operation. Further, the above-described responsiveness of the increase in the pressure becomes noticeably insufficient when the capability of the pump 7 supplying the brake fluid to the wheel cylinder 8 is still insufficient, in particular, the number Nm of rotations of the motor 7a is small. Especially, when the driver starts the operation of pressing the brake pedal, i.e., the pedal stroke Sp is increasing from zero, the motor 7a should be driven from a stopped state and the number Nm of rotations should be increased. However, even when the instruction value Nm* for the number of rotations of the motor is increased, the actual number Nm of rotations of the motor starts increasing while falling behind the increase in the instruction value Nm*. Such a delay (a time lag) in the response of the control highly likely results in the insufficiently of the capability of the pump 7 for performing the wheel cylinder pressure increase control. The apparatus 1 can effectively improve the responsiveness of the increase in the pressure in the wheel cylinder 8 by allowing the assist pressure increase control to be performed in such a case.

More specifically, the assist pressure increase control unit 105 determines that the above-described predetermined sudden brake operation is ongoing if the brake operation speed (the pedal stroke speed ΔSp/Δt) detected or estimated by the brake operation state detection unit 101 is a predetermined value α (a threshold value for determining whether to start or end the assist pressure increase control) or higher, and determines that the above-described predetermined sudden brake operation is not ongoing if ΔSp/Δt is lower than α. When determining that the sudden brake operation is ongoing, the assist pressure increase control unit 105 performs the assist pressure increase control as described above if the number Nm of rotations of the motor 7a detected or estimated based on the signal detected by the resolver is a predetermined value Nm0 (a threshold value for determining to end the assist pressure increase control) or smaller and the detected pedal stroke Sp is a predetermined value Sp0 (a threshold value for determining to end the assist pressure increase control) or smaller. On the other hand, even when determining that the sudden brake operation is ongoing, the assist pressure increase control unit 105 determines that a condition for ending the assist pressure increase control is satisfied and does not perform the assist pressure increase control is Nm is larger than Nm0 or Sp is larger than Sp0. In this case, the wheel cylinder hydraulic control unit 104 controls the second SS/V IN 230 in the valve-closing direction and the SS/V OUT 24 in the valve-opening direction, thereby performing the normal boosting control (the wheel cylinder pressure increase control using the pump 7). As a result, the assist pressure Increase control is ended. Any one or two of the threshold values as the threshold values for determining to end the assist, pressure increase control, such as α, may be omitted.

[Functions]

Next, functions will be described. FIG. 3 is a diagram similar to FIG. 1 that illustrates the activation state of the apparatus 1 at the time of the normal wheel cylinder pressure increase control. The flow of the brake fluid is indicated by an alternate long and short cash line. At the time of the by-wire control, the brake fluid discharged from the pump 7 flows into the first oil passage 11B via the discharge oil passage 16 when the normal wheel cylinder pressure increase control using the pump 7 is performed. This brake fluid flows into each of the wheel cylinders 8, by which the pressure in each of the wheel cylinders 8 is increased. In other words, the pressure in the wheel cylinder 8 is increased with use of the hydraulic pressure generated in the first oil passage 11B with use of the pump 7. On the other hand, the SS/V OUT 24 is controlled in the valve-opening direction. As a result, communication is established between the backpressure chamber 512 of the stroke simulator 5 and the intake oil passage 15 (the reservoir tank 4) side. Therefore, the brake fluid is discharged from the master cylinder 3 according to the operation of pressing the brake pedal 2, and the piston 52 Is activated when this brake fluid flows into the positive pressure chamber 511 of the stroke simulator 5. As a result, the pedal stroke Sp is generated. The brake fluid flowing out of the backpressure chamber 512 is discharged toward the intake oil passage 15 (the reservoir tank 4) side via the third oil passage 13A and the fourth oil passage 14. The fourth oil passage 14 only has to be connected to a low pressure portion into which the brake fluid can flow, and does not necessarily have to be connected to the reservoir tank 4. Further, the operation reaction force applied to the brake pedal 2 (hereinafter referred to the pedal reaction force) is generated due to the force with which the spring 53 of the stroke simulator 5, the hydraulic pressure in the backpressure chamber 512, and the like press the piston 52. In other words, the stroke simulator 5 generates the characteristic of the brake pedal 2 (the F-S characteristic, which is a relationship of Sp to Fp) at the time of the by-wire control.

Next, the functions will be described more specifically. When the driver performs the brake operation (presses the brake pedal 2 or returns the pressed brake pedal 2) with the shut-off valve 21 controlled In the valve-closing direction and the master cylinder 3 and the wheel cylinders 8 out of communication with each other, the stroke simulator 5 generates the pedal stroke Sp by introducing or discharging the brake fluid from and to the master cylinder 3. More specifically, the brake fluid is delivered out of the master cylinder 3 (the secondary hydraulic chamber 31S) to the second oil passage 12 by an amount according to the pedal stroke Sp. This delivered brake fluid is conveyed into the positive pressure chamber 511 of the stroke simulator 5. Now, assume that P0 represents the atmospheric pressure. The variable volume chamber 513 of the stroke simulator 5 is in communication with the reservoir tank 4 (the atmospheric pressure) via the communication oil passage 10. Therefore, the hydraulic pressure in the variable volume chamber 513 is P0. The hydraulic pressure is the positive pressure chamber 511 of the stroke simulator 5 will be referred to as a positive pressure (a primary pressure) P1, and the hydraulic pressure in the backpressure chamber 512 or the third oil passage 13A will be referred to as a backpressure (a secondary pressure) P2. Assuming that P1 represents a force pressing the piston 52 to the x-axis positive-direction side due to application of the positive pressure P1 (the master cylinder hydraulic pressure Pm as the positive pressure P1) to the first pressure-receiving surface 525 of the piston 52 (the large-diameter portion 521), F1 satisfies F1=P1×A1. Assuming that F2 represents s force pressing the piston 52 to the x-axis negative-direction side due to application of the backpressure P2 to the second pressure-receiving surface 526 of the piston 52 (the small-diameter portion 522 and the like), F2 satisfies F2=P2×A2. Assume that F3 represents a force with which the piston 52 is pressed toward the x-axis negative-direction side due to application of the hydraulic pressure in the region sandwiched by the first and second piton seals 541 and 542 to the outer peripheral surface of the piston 52. In the present embodiment, the hydraulic pressure in the above-described region corresponds to the hydraulic pressure in the variable volume chamber 513, and the hydraulic pressure in the variable volume chamber 513 (the atmospheric pressure P0) is applied to the tapered portion 523, so that F3 satisfies F3=P0×(A1−A2). Assume that F4 represents a force with which the spring 53 biases the piston 52 toward the x-axis negative-direction side. In consideration of balance between the forces applied to the piston 52 while ignoring a frictional force and the like, the strength of the force F1 is equal to a sum of the strengths of the forces F2 to F4 (F1=F2+F3+F4).

When the strength of F1 is larger than the sum of the strengths of the forces F2 to F4 (F2+F3+F4), the piston 52 is stroked toward the x-axis positive-direction side while pressing and compressing the spring 53. As a result, the volume of the positive pressure chamber 511 is increased to cause the brake fluid to flow into the positive pressure chamber 511. Further, the volume of the backpressure chamber 512 is reduced, and the brake fluid flows out of the backpressure chamber 512 to the third oil passage 13A by an amount corresponding to an amount flowing into the positive pressure chamber 511 (according to the pedal stroke Sp). When the piston 52 is stroked toward the x-axis positive-direction side, the volume of the variable volume chamber 513 is reduced. According thereto, the brake fluid is discharged from the variable volume chamber 513 to the reservoir tank 4 via the communication oil passage 10. Further, the master cylinder hydraulic pressure Pm generates the pedal reaction force by being applied to the pressure-receiving surface of the piston 32P of the master cylinder 3. The pedal reaction force corresponds to the pressing force Fp. The force F1 generated by Pm corresponds to the pedal reaction force. When the strength of F1 is generally in balance with the sum of the strengths of F2 to F4, and F3 can be regarded sufficiently weak, the pedal reaction force (corresponding to F1) is determined by the strength of the backpressure P2 (corresponding to F2) and the compression amount of the spring 53 (corresponding to F4) (a stroke amount Sss of the piston 52). For example, an increase in Sp (an increase in Sss) leads to an increase in F1 via an increase in F4 and this is reflected in how the driver feels when performing the brake operation (a pedal feeling) as an increase in the pedal reaction force. In this manner, the pedal force according to the operation performed on the brake pedal 2 is generated.

FIG. 11 is a diagram similar to FIG. 2 that schematically illustrates a configuration of the stroke simulator 5 of the brake apparatus according to a comparative example. In the stroke simulator 5 according to the comparative example, both the diameters of the piston containing portion of the cylinder 50 and the piston 52 are constant in the x-axis direction. The diameter of the piston containing portion is equal to the diameter of the large-diameter portion 501 according to the present embodiment. The diameter of the piston 52 is equal to the diameter of the large-diameter portion 522 of the piston 52 according to the present embodiment. Both the area of the first pressure-receiving surface (the surface 525) of the piston 52 that receives the pressure of the brake fluid in the positive pressure chamber 511, and the area of the second pressure-receiving surface (the surface 526 of the stopper portion 520 and the small-diameter portion 522) of the piston 52 that receives the pressure of the brake fluid in the backpressure chamber 512 are A1. The communication oil passage 10 is opened on the inner peripheral surface of the piston containing portion of the cylinder 50. First and second piston seals 544 and 545 are placed in two grooves 506 and 507 sandwiching this opening in the x-axis direction, respectively. The first piston seal 544 on the x-axis positive-direction side permits a flow of the brake fluid heading from the communication oil passage 10 to the backpressure chamber 512, and prohibits or reduces a flow of the brake fluid in an opposite direction therefrom. The second piston seal 545 on the x-axis negative-direction side permits a flow of the brake fluid heading from the communication oil passage 10 to the positive pressure chamber 511, and prohibits or reduces a flow of the brake fluid in an opposite direction therefrom. The valuable volume chamber is not set in a region sandwiched by the first and second piston seals 544 and 545. The force F3 pressing the piston 52 toward the X-axis negative-direction side due to application of a hydraulic pressure in this region to the outer peripheral surface of the piston 52 is zero. Other configurations of the comparative example are similar to the first embodiment.

In the apparatus 1 according to the present embodiment, the backpressure chamber 512 of the stroke simulator 5 is in communication with the reservoir tank 4 side via the fourth oil passage 14 with the SS/V OUT 24 controlled in the valve-opening direction. Therefore, P2 can be regarded to be P2=P0. Therefore, since the force F2 is F2=P0×A2, the forces are applied as F2+F3=P0×A1 and therefore are applied in a similar manner to the above-described comparative example in which the piston 52 is the non-stepped large-diameter piston (the pressure-receiving area of the piston 52 that receives the backpressure P2 is A1). The force due to the atmospheric pressure P0 is applied as the forces F2+F3 derived from the hydraulic; pressure among the forces pressing the piston 52 toward the x-axis negative-direction side, and therefore the strength thereof is relatively weak. Therefore, the biasing force F4 due to the spring 53 mainly serves as the force that presses the piston 52 toward the x-axis negative-direction side, i.e., the force transmitted to the brake pedal 2 via the master cylinder 3 as the reaction force. In other words, the F-S characteristic is generated by the spring 53. Now, F4 is a value acquired by multiplying the stroke amount Sss of the piston 52 by a spring constant of the sprint 53. Sss is the compression amount of the spring 53, and is proportional to the pedal stoke Sp. The spring 53 is not limited to the spring including the first and second springs 531 and 532, and may be embodied with use of, for example, a single coil spring and may employ an arbitrary configuration. In the present embodiment, the spring 53 includes the first rind second springs 531 and 532. Therefore, a characteristic of a change in F4 with respect to Sss (Sp) can be easily arbitrarily set. For example, the F-S characteristic can also be set so as to approximate the F-S characteristic of the brake apparatus including the negative-pressure booster. In this manner, the stroke simulator 5 simulates fluid stiffness of the wheel cylinder 9 or the like and reproduces an appropriate pedal pressing feeling by introducing the brake fluid from the master cylinder 3 therein and also generating the pedal reaction force. The present embodiment includes the piston seals 541 and 542 that seal between the positive pressure chamber 511 and the backpressure chamber 512, which further reliably liquid-tightly separates the positive pressure chamber 511 and the backpressure chamber 512. Therefore, the apparatus 1 can improve the above-described function.

If there is a possibility that the responsiveness of the increase in the pressure in the wheel cylinder 8 with use of the pump 7 may become insufficient, the apparatus 1 performs the assist pressure increase control using the operation of pressing the brake pedal 2 in addition to the normal wheel cylinder pressure increase control vising the pump 7. FIG. 4 is a diagram similar to FIG. 1 that illustrates the activation state of the apparatus 1 at the time of the assist pressure increase control. The flow of the brake fluid is indicated by an alternate long and short dash line. When performing the assist pressure increase control, the apparatus 1 controls the SS/V OUT 24 In the valve-closing direction and the second SS/V IN 230 in a valve-closing direction. As a result, the communication between the backpressure chamber 512 of the stroke simulator 5 and the intake oil passage 15 (the reservoir tank 4) side is blocked, and the communication between the backpressure chamber 512 and the first oil passage 11 side is established. In other words, the communication between the backpressure chamber 512 and the reservoir tank 4 side is blocked since the SS/V OUT 24 is controlled in the valve-closing direction. On the other hand, even with the second SS/V IN 230 controlled in the valve-closing direction, the brake fluid is permitted to flow from the backpressure chamber 512 side (the third oil passage 13A) toward the first oil passage 11 side (the third oil passage 13B) via the first SS/V IN 23. Therefore, while the hydraulic pressure P2 on the backpressure chamber 512 side (the third oil passage 13A) with respect to the first SS/V IN 23 is higher than the hydraulic pressure on the first oil passage 11 side (the third oil passage 13B) with respect to the first SS/V IN 23 (the hydraulic pressure Pw in the wheel cylinder 8 that is increased by the pump 7) according to the pressing of the brake pedal 2, the first SS/V IN 23 is automatically opened, causing the brake fluid to flow from the backpressure 512 side (the third oil passage 13A) toward the first oil passage 11 side (the third oil passage 13B). Then, each of the communication valves 26P and 26S is controlled in the valve-opening direction, so that the backpressure chamber 512 side (the third oil passage 13A) is in communication with each of the wheel cylinders 8. The brake fluid flowing out of the backpressure chamber 512 flows into each of the wheel cylinders 8, by which the pressure is increased in each of the wheel cylinders 8. In other words, the pressure in the wheel cylinder 8 is increased by the supply of the brake fluid flowing out of the backpressure chamber 512 of the stroke simulator 5 activated by the pressing force Fp input from the driver into the first oil passage 11B via the third oil passage 13. This aids the generation of Pw with use of the pump 7, thereby succeeding in improving the speed at which the pressure is increased in the wheel cylinder 8 (the responsiveness of the increase in the pressure).

Now, the pedal reaction force is generated due to the force with which the spring 53 and the backpressure P2 press the piston 52 (F2+F4) (because F3 is sufficiently weak). P2 is higher than P0 (P2>P0) and exhibits a value close to Pw (P2≈Pw) with the brake fluid supplied from the backpressure chamber 512 side (the third oil passage 13A) to the first oil passage 11 side (the third oil passage 13B) via the first SS/V IN 23. Therefore, the force F2 derived from the hydraulic pressure P2 among the forces pressing the piston 52 toward the x-axis negative-direction side corresponds to Pw, so that the strength thereof is relatively great. Therefore, a large pressing force Fp is required (the pedal reaction force is increased) with respect to the same pedal stroke Sp, compared to the pressing force Fp at the time of the normal wheel cylinder pressure increases control in which P2 close to P0 on the reservoir tank 4 side is applied to the backpressure chamber 512 and the force F2 derived from P2 corresponds to P0. The area A2 of the second pressure-receiving surface of the piston 52 is smaller than the area A1 of the second pressure-receiving surface according to the comparative example. Therefore, F2 is weaker than the comparative example if P2 is the same therebetween. Therefore, the pedal reaction force falls below the comparative example at the time of the assist pressure increase control. In other words, if F3 and F4 are ignored, F1=F2, i.e., P1×A1=P2×A2 is satisfied. This means that P2 is increased relative to P1 by an amount as large as a ratio of A1 to A2. In other words, P2 higher than P1 (Pm) can be generated due to the reduction in A2 compared to A1. In other words, higher P2 (Pw) can be generated than the above-described comparative example (both the areas of the first and second pressure-receiving surfaces are A1 and are not different from each other) even with the same pressing force Fp (Pm). Therefore, the apparatus 1 can improve efficiency of the force when Pw is increased with use of the brake fluid flowing out of the backpressure chamber 512. In other words, the apparatus 1 can increase the pressure in the wheel cylinder 8 further early even when the pressure in the wheel cylinder 8 is expected to be increased with use of the pump 7 at an insufficient speed (with insufficient responsiveness of the increase in the pressure).

The satisfaction with the predetermined condition makes sufficient the responsiveness of the increase in the pressure with use of the pump 7, allowing Pw to be increased to a higher value than Pm with use of the pump 7 (the boosting control), and increased at a higher speed than Pp. Therefore, the apparatus 1 ends the assist pressure increase control, and performs only the normal wheel cylinder pressure increase control using the pump 7. More specifically, when the hydraulic pressure (the hydraulic pressure Pw in the wheel cylinder 8 that is increased with use of the pump 7) on the first oil passage 11B side (the third oil passage 13B) with respect to the first SS/V IN 23 exceeds the hydraulic pressure P2 on the backpressure chamber 512 side (the third oil passage 13A) with respect to the first SS/V IN 23 according to the activation of the pump 7, the brake fluid stops flowing from the backpressure chamber 512 side (the third oil passage 13A) to the first oil passage 11B side (the third oil passage 13B). Further, the second SS/V IN 230 is controlled in the valve-closing direction. Therefore, the apparatus 1 ends the increase in the pressure in the wheel cylinder 8 with use of the brake fluid flowing out of the backpressure chamber 512. Further, when Pw exceeds P2, the first SS/V IN 23 is automatically closed. As a result, a reverse flow of the brake fluid from the wheel cylinder 8 side (the third oil passage 13B) to the backpressure chamber 512 side (the third oil passage 13A) is prevented or reduced. At this time, the SS/V OUT 24 is controlled in the valve-opening direction while the second SS/V IN 230 is kept controlled in the valve-closing direction. Due to this control, the flow passage of the above-described brake fluid flowing out of the backpressure chamber 512 according to the brake operation performed by the driver is switched from the flow passage flowing toward the first oil passage 11B via the third oil passage 13 to the flow passage flowing toward the intake oil passage 15 (the reservoir tank 4) via the fourth oil passage 14. In other words, the apparatus 1 switches the communication state of the third oil passage 13 by automatically activating the first SS/V IN 23 so as to open or close this value according to the difference between P2 and Pw, thereby switching whether to supply the brake fluid from the backpressure chamber 512 to the wheel cylinder 8. In this manner, the SS/V OUT 24 and the first SS/V IN 23 function as a flow passage switching unit that switches the above-described flow passage (a switching unit that switches the connection between the connection between the backpressure chamber 512 and the first oil passage 11B via the third oil passage 13 and the connection between the backpressure chamber 512 and the reservoir tank 4 via the fourth oil passage 14).

If satisfaction of the sufficient responsiveness of the increase in the pressure in the wheel cylinder with use of the hydraulic source is attempted assuming such a case that the pressure in the wheel cylinder is required to be increased rapidly, such as when the driver performs the brake operation rapidly, this attempt raises a necessity of improvement of the capability of the actuator regarding the hydraulic source, thereby leading to a possibility of increases in the size and the cost of the actuator. Alternatively, an addition of a new hydraulic source may result in increases in the size and cost of the apparatus. On the other hand, the apparatus 1 allows the brake fluid to be supplied to the wheel cylinder 8 with use of the brake fluid discharged from the stroke simulator 5 activated by being subjected to the brake operation force input from the driver (according to the driver's brake operation for the simulation of the pedal reaction force). As a result, the apparatus 1 can improve the responsiveness of the increase in the pressure in the wheel cylinder 8. Therefore, the motor 7a does not have to be increased in size and does not require high cost to improve the capability of the motor 7a as the actuator regarding the pump 7. Further, no need arises for the addition of a new hydraulic source, too. Therefore, mountability of the apparatus 1 onto the vehicle and layout flexibility of the apparatus 1 can be improved. In the present embodiment, the apparatus 1 uses the pump 7 as the hydraulic source and the motor 7a (the rotational electric machine) as the actuator regarding the hydraulic source, but the hydraulic source may be any fluid mechanism capable of generating the brake hydraulic pressure by converting mechanical energy (motive power) into the brake hydraulic pressure, and maintaining the generated brake hydraulic pressure. For example, the hydraulic source may be embodied with use of a piston cylinder, an accumulator, or the like, and is not limited to the pump. Further, the actuator may be any mechanism (an electric machine) capable of converting input electric energy (electric power) into a physical motion (motive power) to activate the hydraulic source, and is not limited to the motor (the rotational electric machine).

The brake apparatus discussed in PTL 1 (hereinafter referred to as the conventional technique) can generate the hydraulic pressure in the wheel cylinder with use of the accumulator, and also provides the hydraulic fluid discharged from the backpressure side of the stroke simulator to the accumulator side. The piston of the stroke simulator has a large diameter on the master cylinder side and a small diameter on the backpressure side, so that the pressure-receiving area of the piston on the master cylinder side is larger than the pressure-receiving area on the backpressure side thereof. Therefore, the hydraulic pressure on the backpressure side of the piston is increased to a higher pressure than the hydraulic pressure on the master cylinder side. Due to this configuration, the conventional technique attempts to reduce frequency of the operation of the motor and the pump driven for pressure accumulation of the accumulator. However, the conventional technique is configured to supply the hydraulic fluid from the backpressure side to the accumulator side during the by-wire control constantly. i.e., uniformly regardless of whether the responsiveness of the increase in the pressure in the wheel cylinder is currently requested. Therefore, a ratio as large as ten times is required as the ratio between the cross-sectional areas of the small-diameter portion and the large-diameter portion of the piston of the stroke simulator (the ratio of the pressure-receiving area on the master cylinder side to the pressure-receiving area on the backpressure side of the piston) to avoid an excessive increase in the reaction force to the brake operation member. This means that, with respect to the above-described fluid amount supplied to the master cylinder side of the piston, only a fluid amount as little as approximately one-tenth thereof is supplied from the backpressure side. Therefore, the conventional technique fails to supply a sufficient fluid amount to the wheel cylinder even when attempting to increase the pressure in the wheel cylinder with use of the brake fluid from the backpressure side, which makes it difficult to improve the responsiveness of the increase in the pressure in the wheel cylinder.

On the other hand, in the apparatus 1, the first SS/V IN 23 provided in the third oil passage 13 and the SS/V OUT 24 provided in the fourth oil passage 14 function as the switching unit that switches the connection between the connection between the backpressure chamber 512 and the first oil passage 11B (the wheel cylinder 8 side) and the connection between the backpressure chamber 512 and the low pressure portion (the reservoir tank 4 and the like) (switches the connection destination of the backpressure chamber 512 to the first oil passage 11B or the low pressure portion 4 and the like). Therefore, in such a scene that the responsiveness of the increase in the pressure in the wheel cylinder 8 is not requested as Pw is already increased to some degree, the apparatus 1 connects the backpressure chamber 512 to the low pressure portion 4 or the like, thereby succeeding in reducing the hydraulic pressure P2 applied to the backpressure side of the piston 52 of the stroke simulator 5. Therefore, the apparatus 1 can prevent an excessive increase in the pedal reaction force even when reducing to some degree the ratio of the pressure-receiving area A1 (facing the positive pressure chamber 511) on the master cylinder 3 side to the pressure-receiving area A2 (facing the backpressure chamber 512) on the backpressure side of the piston 52. Then, the apparatus 1 can increase the fluid amount supplied from the backpressure chamber 512 by increasing the pressure-receiving area A2 on the backpressure side of the piston 52 to some degree. Therefore, the apparatus 1 can supply a sufficient fluid amount from the backpressure chamber 512 to the wheel cylinder 8 by connecting the backpressure chamber 512 to the first oil passage 11B in such a scene that the responsiveness of the increase in the pressure in the wheel cylinder 8 is requested. Therefore, the apparatus 1 can improve the responsiveness of the increase in the pressure in the wheel cylinder 8. The apparatus 1 can produce a higher pressure as the hydraulic pressure P2 on the backpressure side than the hydraulic pressure P1 (Pm) on the master cylinder 3 side since the pressure-receiving area A2 or the backpressure side of the piston 52 is smaller than the pressure-receiving area A1 on the master cylinder 3 side, similarly to the conventional technique. The apparatus 1 can further improve the responsiveness of the increase in the pressure in the wheel cylinder 8 by supplying the brake fluid boosted in this manner to the wheel cylinder 8 side. Now, for example, an O-ring may be used as the piston seal (s) 541 and/or 542 in the stroke simulator 5, instead of the cup seal.

Further, the conventional technique is configured, to constantly supply the hydraulic fluid from the backpressure side of the stroke simulator to the accumulator side. Therefore, it is difficult to establish an appropriate F-S characteristic and realize an excellent pedal feeling. More specifically, the backpressure applied to the piston of the stroke simulator is reflected into the master cylinder hydraulic pressure and the force pressing the brake pedal as the reaction force. Therefore, it is highly possible that the F-S characteristic varies and the pedal feeling undesirably changes every time the pedal is operated in various scenes when the vehicle is driven, such as when the pedal is pressed to lead to the increase in the backpressure, when the pedal is returned to lead to a reduction in the backpressure to a negative pressure, when the brake pedal is pressed twice, when the wheel cylinder hydraulic pressure control is performed. On the other hand, the apparatus 1 connects the backpressure chamber 512 to the low pressure portion 4 or the like at the time of the normal by-wire control (in which the assist pressure increase control is not performed). Therefore, the F-S characteristic is generated by the spring 53 of the stroke simulator 5, so that the variation thereof is prevented or reduced. Therefore, the apparatus 1 can realize an excellent pedal feeling. As described above, P2 exhibits a value close to Pw at the time of the assist pressure increase control. This means that the pedal reaction force is slightly increased and the F-S characteristic is slightly changed compared to when the normal wheel cylinder pressure increase control is performed. However, the assist pressure increase control is performed when the operation of pressing the brake pedal is performed (a dynamic scene where Fp and Sp are changing), whereby this unevenness of the characteristic can be accepted to some degree (it is relatively less likely that the control makes the driver feel uncomfortable). Further, if the assist pressure increase control continues for an excessively long time period, this control may make the driver feel uncomfortable, deteriorating the pedal feeling. On the other hand, the apparatus 1 is configured in such a manner that the first SS/V IN 23 is automatically closed when Pw exceeds P2. By this control, the apparatus 1 can end the assist pressure increase control before P2 is excessively increased, thereby succeeding in preventing or reducing the deterioration of the pedal feeling.

In the apparatus 1, the third oil passage 13 is directly connected to the portion in the first oil passage 11 between the shut-off valve 21 and the wheel cylinders 6 (the first oil passage 11B), but may be indirectly connected. For example, the third oil passage 13 may be connected to the discharge oil passage 16. Further, the apparatus 1 may include an orifice portion in the third oil passage 13 or the fourth oil passage 14 instead of the valves 23 and 24 and adjust the fluid amount passing through this orifice portion (an orifice amount or a flow passage resistance), thereby switching the flow passage of the brake fluid flowing out of the backpressure chamber 512 between the flow passage flowing toward the first oil passage 11 via the third oil passage 13 and the flow passage flowing toward the intake oil passage 15 (the reservoir tank 4) via the fourth oil passage 34 (causing the orifice portion to function as the above-described switching unit). On the other hand, the apparatus 1 forms the above-described switching unit with use of the valves 23 and 24 provided in the third oil passage 13 and the fourth oil passage 14, thereby allowing the oil passages 13 and 14 to further reliably establish and block the communication and thus allowing the above-described switching to be easily realized. The first SS/V IN 23 is the check valve that permits only the flow heading from the backpressure chamber 512 toward the first oil passage 11B. Therefore, the apparatus 1 can simply form the above-described switching unit compared when the electromagnetic valve is used as the first SS/V IN 23. Further, this configuration eliminates the necessity of the operation of opening and closing the first SS/V IN 23 when starting and ending the assist pressure increase control, thereby contributing to improving the noise and vibration performance of the apparatus 1.

The apparats 1 may be configured not to include the second SS/V IN 230. Since the apparatus 1 includes the second SS/V IN 230 that is the electromagnetic valve, for example, when the anti-lock control is activated during the wheel cylinder hydraulic pressure control (the by-wire control) according to the brake operation, the apparatus 1 can make the user aware of that. More specifically, in the anti-lock control, the apparatus 1 controls the opening/closing of the SOL/VIN 25 and the SOL/V OUT 28 corresponding to the wheel cylinder 8 at the wheel slipping by an excessive amount with the pump 1 kept activated and the shut-off valve 21 kept controlled in the valve-closing direction. By this control, the apparatus 1 performs the control for increasing or reducing the hydraulic pressure in this wheel cylinder 8, thereby allowing the slip amount of this wheel to reduce to an appropriate predetermined value. Then, the apparatus 1 can provide a stroke to the piston 52 with use of the hydraulic pressure generated with the aid of the pump 7 by controlling the SS/V OUT 24 and the second SS/V IN 230, thereby controlling the position of the piston 32. For example, the apparatus 1 can also to configured to displace (vibrate) the brake pedal 2 forward and backward (in the return direction and the advance direction). Therefore, the apparatus 1 can realize a similar reaction of the brake pedal 2 to the conventional brake apparatus, thereby realizing a pedal feeling that makes the driver less uncomfortable. Further, the apparatus 1 may activate the second SS/V IN 230 (control the second SS/V IN 230 in a valve-opening direction) when performing the assist pressure increase control, in this case, the apparatus 1 can improve the responsiveness of the increase in the pressure in the wheel cylinder 8 at the time of the assist pressure increase control. In other words. because a flow passage area can be widened as much as the bypass oil passage 230 in addition to the third oil passage 13, the apparatus 1 can increase the brake fluid amount supplied toward the wheel cylinder 3. The second SS/V IN 230 may be a normally-opened valve.

Further, the SS/V OUT 24 is the electromagnetic valve (a control valve), the valve-opening state (opening/closing) of which can be controlled according to the control signal. Therefore, the apparatus 1 can further easily switch the communication state of the fourth oil passage 14, thereby improving controllability when performing the assist pressure increase control. For example, when the SS/V IN 23 is opened (when Pw is lower than P2), the apparatus 1 controls the SS/V OUT 24 in the valve-closing direction, thereby prohibiting or reducing the discharge of the brake fluid output from the backpressure chamber 512 toward the reservoir tank 4 side. As a result, the apparatus 1 can increase the brake fluid amount to be supplied from the backpressure chamber 512 toward the wheel cylinder 8 side via the first oil passage 11B, thereby improving the responsiveness of the increase in the pressure in the wheel cylinder 8. After the SS/V IN 23 is closed (Pw exceeds P2), the apparatus 1 controls the SS/V OUT 24 in the valve-opening direction, which facilitates the discharge of the brake fluid flowing out of the backpressure chamber 512 to the reservoir tank 4 side. As a result, the apparatus 1 can make the activation of the stroke simulator 5 (the stroke of the piston 52) smooth. In other words, the apparatus 1 can appropriately generate the pedal feeling. The apparatus 1 allows the SS/V IN 23 to be opened and closed at a timing close to when the SS/V IN 23 is opened and closed in the above-described manner, by determining, based on the values of ΔSp/Δt, Nm, and Sp, whether to perform the assist pressure increase control. The SS/V OUT 24 may be a normally-opened valve. Further, the apparatus 1 may control the second SS/V IN 230 or the SS/V OUT 24 so as to repeatedly open and close this value at the end of the assist pressure increase control. By this control, the apparatus 1 can prevent or reduce a sudden change in P2, thereby preventing or reducing the deterioration of the pedal feeling. Further, the second SS/V IN 230 or the SS/V OUT 24 may be a proportional control valve. In this case, the apparatus 1 can prevent or reduce the sudden change in P2 by controlling an opening degree (a valve opening amount) of the second SS/V IN 230 or the SS/V OUT 24 at the end of the assist pressure increase control.

The valve (the SS/V OUT 24) for stopping the activation of the stroke simulator 5 is not disposed on one side of the stroke simulator 5 where the positive pressure chamber 511 is located (the second oil passage 12) but is disposed on the other side where the backpressure chamber 512 is located (the fourth oil passage 14). Therefore, the apparatus 1 can improve the pedal feeling around the end of the assist pressure increase control. More specifically, hypothetically suppose that the SS/V OUT is disposed on the positive pressure chamber 511 side (the second oil passage 12). In this case, it is also conceivable to realize the assist pressure increase control by employing a control configuration that controls the above-described SS/V OUT in the valve-closing direction and the shut-off valve 21 in the valve-opening direction to supply the brake fluid from the master cylinder 3 to the wheel cylinder 8. This configuration leads to closing the shut-off valve 21 and opening the SS/V OUT when ending the assist pressure increase control and shifting to the normal wheel cylinder pressure increase control. However, the brake fluid is not supplied to the stroke simulator 5 and the stroke simulator 5 is deactivated during the assist pressure increase control. Therefore, how much the stroke simulator 5 is activated (the stroke amount of the piston 52, i.e., the deformation amount of the spring 53) at the time of the above-described shift cannot correspond to Sp at the time of the above-described shift. Therefore, the pedal stroke Sp and the pressing force Fp have a different F-S characteristic therebetween at the time of the above-described shift from the F-S characteristic when the assist pressure increase control is not performed (at the time of the normal control). Further, the brake fluid amount left on the master cylinder 3 side of the stroke simulator 5, i.e., the upstream side of the shut-off valve 21S and the positive pressure chamber 511 side (left between the secondary hydraulic chamber 31S of the master cylinder 3, the first oil passage 11S (11A) and the second oil passage 12, and the positive pressure chamber 511) after the above-described shift is smaller by an amount as much as the fluid amount supplied to the wheel cylinder 8 before the above-described shift, compared to when the normal control is performed. As a result, the master cylinder 3 side of the stroke simulator S is prone to have a negative pressure therein. In other words, the input and the output of tho fluid amount do not match each other on the master cylinder 3 side of the stroke simulator 5 between before and after the above-described shift, thereby resulting in unevenness of the F-S characteristic. Therefore, this configuration may make the driver feel uncomfortable.

On the other hand, in the apparatus 1, the SS/V OUT 24 is not disposed on the positive pressure chamber 511 side but is disposed on the backpressure chamber 512 side (the fourth oil passage 14). Therefore, the piston 52 of the stroke simulator 5 continues the stroke as much as the brake fluid amount flowing out of tho master cylinder 3 according to the operation of pressing the brake pedal throughout before and after the end of the assist pressure increase control. In other words, the brake fluid is continuously supplied to the stroke simulator 5 (the positive pressure chamber 511) not only during the normal wheel cylinder pressure increase control using the pump 7 but also during the assist pressure increase control, keeping the stroke simulator activated. Therefore, how much the stoke simulator 5 is activated (the stroke amount Sss of the piston 52, i.e., the compression amount of the spring 53) at the time of the end of the assist, pressure increase control corresponds to Sp at the time of the above-described end. Further, the brake fluid is confined between the secondary hydraulic chamber 31S of the master cylinder 3, the first oil passage 11B and the second oil passage 12, and the positive pressure chamber 511 (between the piston 32S, the shot-off valve 21S, and the piston 52) by an amount unchanged between before and after the above-described end. In other words, the input and the output of the fluid amount match each other on the positive pressure chamber 511 side, which also reduces the possibility of the unevenness of the F-S characteristic between before and after the above-described end. Therefore, the apparatus 1 can realize the pedal feeling that makes the driver further less uncomfortable. In other words, in the assist pressure increase control of the apparatus 1, the apparatus 1 only switches the supply destination of the brake fluid discharged from the stroke simulator 5 from the reservoir tank 4 side to the wheel cylinder 8 side, so that the activation of the stroke simulator 5 (the stroke of the piston 52) itself is not interrupted. The stroke simulator 5 can function as the brake fluid supply source that supplies the brake fluid to the wheel cylinder 8, and at the same time, can exert the originally intended function of simulating the pedal reaction force Fp. Therefore, the apparatus 1 can prevent or reduce the deterioration of the pedal feeling. In other words, in the assist pressure increase control of the apparatus 1, the brake fluid is not directly supplied from the master cylinder 3 to the wheel cylinder 8 but is (indirectly) supplied from the stroke simulator 5 (the backpressure chamber 512) to the wheel cylinder 8. Therefore, the input and the output of the fluid amount can match each other en the master cylinder 3 side (the positive pressure side) of the stroke simulator 5 between before and after the assist pressure increase control. Therefore, even when performing the assist pressure increase control, the apparatus 1 can easily keep smooth the activation of the master cylinder 3 and the pistons 32 and 52 of the stroke simulator 5. Therefore, the apparatus 1 can easily prevent or reduce the deterioration of the pedal feeling.

At the time of the by-wire control, when the driver performs the return operation from the state in which the brake pedal 2 is pressed, the pistons 32 and 52 of the master cylinder 3 and the stroke simulator 5 attempt to return to original positions thereof (positions thereof corresponding to the same pedal stroke Sp when the pedal is pressed). FIG. 5 is a diagram similar to FIG. 1 that illustrates the activation state of the apparatus 1 when the pedal return operation is performed during the execution of the wheel cylinder pressure increase control using the pump 7. The flow of the brake fluid is indicated by an alternate long and short dash line. When the strength of F1 falls below the sum of the strengths of F2 to F4(F2+F3+F4), the piston 52 attempts to recover toward the initial position thereof (toward the x-axis negative-direction side). The backpressure chamber 512 attempts to expand the volume thereof. At this time, the brake fluid is supplied from a side where the first pressure reduction oil passage 17 and the intake oil passage 15 are located to the third oil passage 13A side while passing through the fourth oil passage 14 (the SS/V OUT 24) and the bypass oil passage 140 (the check valve 240), and flows into the backpressure chamber 512 via the third oil passage 13A. At this time, the SS/V OUT 24 (the flow passage of the brake fluid inside thereof) functions as an orifice in the above-described return oil passage leading to the backpressure chamber 512. Due to this function, the hydraulic pressure P2 on the third oil passage 13A side may fall below the hydraulic pressure P0 on the side where the first pressure reduction oil passage 17 and the intake oil passage 15 are located, between opposite sides of the SS/V OUT 24 in the fourth oil passage 14. More specifically, the provision of the SS/V OUT 24 in the fourth oil passage 14 leads to a limit imposed on the amount of the brake fluid supplied to the third oil passage 13A side via the SS/V OUT 24 (the brake fluid flowing into the backpressure chamber 512) when the piston 52 returns, increasing a possibility of occurrence of a negative pressure (<P0) in the backpressure chamber 512. In this case, the piston 52 becomes difficult to return to the original position thereof. Especially, when P1 exhibits a positive value, a large difference is generated between P2 (the negative pressure) and P1 to make the return of the piston 52 difficult. According thereto, the pistons 32 of the master cylinder 3 also become difficult to return, so that the brake pedal 2 also becomes difficult to return. Further, if the brake pedal 2 is pressed again without the piston 52 yet retracted back to the original position thereof, the F-S characteristic changes and the pedal feeling undesirably changes from the pedal feeling when the pedal is pressed last time. Therefore, this control may make the driver feel uncomfortable. Increasing the spring constant of the spring 53 to facilitate the return of the piston 52 may also lead to deterioration of the F-S characteristic, such as an increase in Fp for increasing Sp at an early stage of the brake operation.

On the other hand, the variable volume chamber 513 is in communication with the reservoir tank 4 via the communication oil passage 10. The second piston seal 542 permits the flow of the brake fluid heading from the variable volume chamber 513 toward the backpressure chamber 512. Therefore, the brake fluid in the variable volume chamber 513 that is supplied from the communication oil passage 10 is supplied to the backpressure chamber 512 while passing through between the lip portion 342a as the one-way seal portion of the second piston seal 542 and the small-diameter portion 522 of the piston 52 due to the difference between the pressure in the variable volume chamber 513 (the atmospheric pressure P0) and the pressure P2 in the backpressure chamber 512 (the negative pressure). In other words, the one-way seal portion (the lip portion 542a) of the second piston seal 542 functions as a supply portion that supplies the brake fluid supplied from the communication oil passage 10 to the backpressure chamber 512. This makes it easier for the piston 52 to return to the original position thereof. In other words, even when the brake fluid in the backpressure chamber 512 becomes insufficient, the apparatus 1 can reduce a time period for which the generation of the negative pressure is kept in the backpressure chamber 512. Therefore, the apparatus 1 can improve the phenomenon that this negative pressure makes the return of the piston 52 difficult, thereby improving the difficulty in the return of the brake pedal 2. Further, even when the brake pedal 2 is pressed twice, the change in the F-S characteristic is prevented or reduced. In this manner, the activation of the stroke simulator 5 is stabilized, so that the pedal feeling can be improved. Now, no electromagnetic valve (serving as an orifice) is interposed in the above-described supply passage via the second piston seal 542. Therefore, the brake fluid can be efficiently supplied. An oil passage or the like may be additionally provided at the cylinder 50 or the like as the above-described supply portion. On the other hand, the apparatus 1 uses the cup seal (the second piston seal 542) as the above-described supply portion. Therefore, the apparatus 1 can simplify the configuration, thereby reducing the size of the stroke simulator 5.

The bypass oil passage 140 and the check valve 240 may be omitted. However, in the present embodiment, the check valve 240 (the bypass oil passage 140) permits the flow of the brake fluid heading from the side where the first pressure reduction oil passage 17 and the intake oil passage 15 are located toward the third oil passage 13A side. Therefore, the apparatus 1 can allow the brake fluid to be further efficiently returned to the backpressure chamber 512 and facilitate the recovery of the piston 52. In other words, the apparatus 1 can allow the brake fluid to be returned from the side where the intake oil passage 15 and the like are located to the backpressure chamber 512 side (the third oil passage 13A) via the bypass oil passage 140 regardless of the activation state of the SS/V OUT 24. For example, the apparatus 1 allows the driver to return the pressed brake pedal 2 swiftly even in such a case that the SS/V OUT 24 is switched from the valve-closing state to the valve-opening state late due to a control delay when the pressed brake pedal 2 is returned during the assist pressure increase control. Further, even if a failure (a power failure or the like) has occurred while the brake pedal 2 is being pressed (while the stroke simulator 5 is in operation) and the SS/V OUT 24 is stuck in the valve-closing state, the apparatus 1 can allow the brake fluid to be returned from the reservoir tank 4 side to the backpressure chamber 512 via the bypass oil passage 140 according to the return of the pressed brake pedal 2. Therefore, even when the above-described failure has occurred, the apparatus 1 can allow the driver to return the pressed brake pedal 2 to an initial position thereof while allowing the stroke simulator 9 to be returned to the initial activation position thereof.

Further, if the driver performs the return operation from the state in which the brake pedal 2 is pressed during the by-wire control, the piston 32S of the master cylinder 3 attempts to recover toward the initial position thereof (toward the x-axis negative-direction side). The secondary hydraulic chamber 31S attempts to expand the volume thereof. At this time, the brake fluid is supplied from the replenish port 301 (the reservoir tank 4 side) to the secondary hydraulic chamber 315 while passing through the first piston seal 341S. Since the shut-off valve 21S is controlled in the valve-closing direction, the oil passage through which the brake fluid returns from the wheel cylinders 8 side to the secondary hydraulic chamber 31S side while passing through the shut-off valve 2S is blocked. Therefore, the secondary hydraulic chamber 31S attempting to expand according to the displacement of the piston 32S is prone to have a negative pressure therein despite the supply of the brake fluid from the replenish port 301 (even if the shut-off valve 21S is opened, a negative pressure is prone to occur in the hydraulic chamber 31S because the flow passage of the brake fluid inside the shut-off valve 21S functions as an orifice in the above-described return oil passage).

On the other hand, when the secondary hydraulic chamber 31S has a negative pressure therein, the positive pressure chamber 511 in communication with the secondary hydraulic chamber 31S via the second oil passage 12 also has a negative pressure therein. The first, piston seal 541 of the stroke simulator 5 permits the flow of the brake fluid heading from the variable volume chamber 513 toward the positive pressure chamber 511. Therefore, the brake fluid in the variable volume chamber 513 that is supplied from the communication oil passage 10 is supplied to the positive pressure chamber 511 while passing through between the lip portion 541a as the one-way seal portion of the first piston seal 541 and the large-diameter portion 501 of the piston 52 due to the difference between, the pressure in the variable volume chamber 513 (the atmospheric pressure P0) and the pressure Pm in the positive pressure chamber 511 (the negative pressure). In other words, the one-way seal portion (the lip portion 541a) of the first piston seal 541 functions as a supply portion that supplies the brake fluid from the communication oil passage 10 to the positive pressure chamber 511. The brake fluid supplied to the positive pressure chamber 511 is supplied to the secondary hydraulic chamber 31S via the second oil passage 12. As a result, the apparatus 1 makes it easier for the piston 32S to return to the original position thereof. In other words, the apparatus 1 improves such a phenomenon that the piston 32S (and the piston 32P) becomes difficult to return due to this negative pressure, because of a reduction in a time period during which the generation of the negative pressure is kept in the secondary hydraulic chamber 31S. Therefore, the apparatus 1 improves the difficulty in the return of the brake pedal 2, thereby succeeding in improving the pedal feeling. The above-described supply passage via the first piston seal 541 does not include an electromagnetic valve interposed therein, so that the brake fluid can be efficiently supplied. An oil passage or the like may be additionally provided in the cylinder 50 or the like as the above-described supply portion. On the other hand, the apparatus 1 uses the cup seal (the first piston seal 541) as the above-described supply portion. Therefore, the apparatus 1 can simplify the configuration and reduce the size of the stroke simulator 5.

In this manner, when the secondary hydraulic chamber 31S has a negative pressure therein when the operation of returning the brake pedal 2 is performed, the apparatus 1 allows the brake fluid to be replenished from any or the system of the master cylinder 3 (via the first piston seal 341S) and the system of the stroke simulator 5 (via the first piston seal 541) to the secondary hydraulic chamber 31S. Therefore, even if the apparatus 1 is configured to supply the brake fluid directly from the secondary hydraulic chamber 31S to the wheel cylinder 8 via the shut-off valve 21S when the responsiveness of the increase in the pressure in the wheel cylinder 8 is requested, such as when the sudden brake operation is performed, the apparatus 1 can easily correct a difference between the input and the output of the brake fluid amount on the master cylinder 3 side of the stroke simulator 5. In other words, when the pedal is returned, the apparatus 1 also allows the brake fluid to be replenished from the stroke simulator 5 side to the secondary hydraulic chamber 31S. Therefore, the apparatus 1 allows the brake fluid to be actively supplied from the master cylinder 3 side to the wheel cylinder 8 side without consideration of the difference between the input and the output of the brake fluid amount on the master cylinder 3 side of the stroke simulator 5. For example, the apparatus 1 can perform control such as delaying a time when the shut-off valve 21S is closed and adjusting the valve-opening amount of the shut-off valve 21S to leak the brake fluid to the wheel cylinder 8 side.

Each of the above-described features regarding the returns of the pistons 32 and 52 also applies to the above-described comparative example. More specifically, each of the above-described advantageous effects can be acquired due to the configuration (the first and second piston seals 544 and 545) that functions as the supply portion lot supplying the brake fluid from the communication oil passage 10 to each of the positive pressure chamber 511 and the backpressure chamber 512 even without the piston 52 having the stepped shape (even without the variable volume chamber 513 provided).

The communication oil passage 10 may be connected to a hydraulic source capable of supplying the brake fluid, and does not necessarily have to be connected to the reservoir tank 4. Further, how to unitize each of the components in the hydraulic control unit 6 can be arbitrarily designed. The first and second units 61 and 62 may be integrally provided. In the apparatus 1, the master cylinder 3 and the stroke simulator 5 are the integrally configured unit (the master cylinder unit). The system (the unit forming that) of apparatus 1 has an integrated configuration in this manner, which can improve assemblability of the apparatus 1. Further, the pistons 32 of the master cylinder 3 and the piston 52 of the stroke simulator 5 are disposed on the generally same central axis. Therefore, the layout flexibility of the system (the unit forming that) of the apparatus 1 can be improved. On the other hand, the first unit 61 including the pump 7 is configured separately from the second unit 62 including the above-described master cylinder unit. The pump 7 (the first unit 61) and the second unit 62 are connected to each other via an external pipe. The pump 7 (the first unit 61) and the master cylinder unit (the second unit 62) are configured separately in this manner, which can improve the mountability of the apparatus 1 onto the vehicle 1.

The apparatus 1 includes the fluid pool 15A, but the fluid pool 15A may be omitted therefrom. However, the provision of the fluid pool 15A allows the fluid pool 15A to function as the supply source and the discharge destination (the reservoir) of the brake fluid, even at the time of such a failure that the brake fluid leaks out of the intake oil passage 15 at a portion of the brake pipe that connects the reservoir tank 4 and the first unit 61 (for example, a portion of this brake pile that is connected to the first unit 61). Therefore, the apparatus 1 can continue the boosting control (the increase and the reduction in the wheel cylinder hydraulic pressure) using the pump 7 and the assist pressure increase control. Therefore, the apparatus 1 can acquire a stable brake performance and improve a fail-safe performance.

### Second Embodiment

FIG. 6 is a diagram similar to FIG. 2 that schematically illustrates a configuration of the stroke simulator 5 in the brake apparatus 1 according to a second embodiment. A circumferentially extending groove 505 is provided at the large-diameter portion 501 of the cylinder 50 slightly closer to the x-axis positive-direction side. One end of the communication oil passage 10 is constantly opened to an x-axis negative-direction side of the large-diameter portion 501 and the x-axis negative-direction side with respect to the groove 505. The piston 52 includes a first large-diameter portion 521a, a second large-diameter portion 521b, a first small-diameter portion 522, a first tapered portion 523a, a second tapered portion 523b, and a second small-diameter portion 527. A circumferentially extending recess (the second small-diameter portion 527) is formed at the large-diameter portion of the piston 52 on the x-axis negative-direction side, by which two cylindrical portions having relatively large diameters are defined. The first and second large-diameter portions 521a and 521b arc these cylindrical portions formed in this manner. The first large-diameter portion 522a is provided at the end of the piston 52 on the x-axis negative-direction side (an end of the above-described large-diameter portion on the x-axis negative-direction side), and is configured similarly to the large-diameter portion 521 according to the first embodiment. The second large-diameter portion 521b is provided on an x-axis positive-direction side of the first large-diameter portion 521a (an end of the above-described large-diameter portion on the x-axis positive-direction side) while being spaced apart therefrom by a predetermined distance in the x-axis direction. Diameters of the first and second large-diameter portions 521a and 521b are approximately equal to each other, and are slightly smaller than a diameter of the large-diameter portion 501 of the cylinder 50. The first and second large-diameter portions 521a and 521b are provided on the inner peripheral side of the large-diameter portion 501 of the cylinder 50.

The first small-diameter portion 522 is configured similarly to the first small-diameter portion 522 according to the first embodiment. The second small-diameter portion 527 is a small-diameter cylindrical portion provided between the first and second large-diameter portions 521a and 521b. A diameter of the second small-diameter portion 527 is approximately equal to the first small-diameter portion 522. The first tapered portion 523a is provided between the first large-diameter portion 521a and the second small-diameter portion 527 continuously therefrom. The first tapered portion 523a has a diameter gradually increasing as extending from the x-axis positive-direction side toward the x-axis negative-direction side. The second tapered portion 523b is provided between the second large-diameter portion 521b and the second small-diameter portion 527 continuously therefrom. The second tapered portion 523b has a diameter gradually increasing as extending from the x-axis negative-direction side toward the x-axis positive-direction side. No tapered portion is provided between the second large-diameter portion 521b and the first small-diameter portion 522. A tapered portion may be provided similarly to the first embodiment. An end surface 528 of the second large-diameter portion 521b on the x-axis positive-direction side extends in a direction orthogonal to the axis. An outer peripheral surface of the second large-diameter portion 521b is continuous from an outer peripheral surface of the first small-diameter portion 522 via the surface 528.

A space surrounded by the large-diameter portion 501 and the tapered portion 503 of the cylinder 50, and the outer peripheral surface of the first small-diameter portion 522 and the surface 528 of the second large-diameter portion 521b of the piston 52 is the variable volume chamber 513 having a volume varying according to the displacement of the piston 52 relative to the cylinder 50 in the x-axis direction. A space surrounded by the large-diameter portion 501 of the cylinder 50, and the second small-diameter portion 527 and outer peripheral surfaces of the first and second tapered portions 523a and 523b of the piston 52 is a fixed volume chamber 514 displaceable according to the displacement of the piston 52 relative to the cylinder 50 in the x-axis direction while keeping a constant volume thereof. The communication oil passage 10 is constantly opened to the fixed volume chamber 514 within a range where the piston 52 (the fixed volume chamber 514) is displaceable relative to the cylinder 50 in the x-axis direction.

A third piston seal 543 is placed in the groove 505. The third piston seal 543 is a separation seal member that seals between the positive pressure chamber 511 and the backpressure chamber 512, thereby liquid-tightly separating them. The third piston seal 543 is a cup seal similar to the piston seals 541 and 542, and includes a lip portion 543a on an inner radial side thereof. The third piston seal 543 (the lip portion 543a) is in sliding contact with the second large-diameter portion 521b of the piston 52 on one side in a region sandwiched by the first piston seal 541 and the second piston seal 542 that is located closer to the backpressure chamber 512 (on the x-axis positive-direction side) with respect to the communication oil passage 10. This configuration realises sealing between the outer peripheral surface of the second large-diameter portion 521b end the inner peripheral surface of the cylinder 50 (the large-diameter portion 501). The third piston seal 543 (the lip portion 543a) permits a flow of the brake fluid heading from the fixed volume chamber 514 toward the variable volume chamber 513, and prohibits or reduces a flow of the brake fluid in an opposite direction therefrom. As illustrated in FIG. 6, in an initial state where the piston 52 is not displaced toward the x-axis positive-direction side, the end surface 528 of the second large-diameter portion 521b on the x-axis positive-direction side is positioned on the x-axis negative-direction side with respect to the lip portion 543a of the third piston seal 543. In other words, the above-described lip portion 543a is positioned within the valuable volume chamber 513 without, contacting the outer peripheral surface of the second large-diameter portion 521b. When the piston 52 is displaced from the above-described initial state toward the x-axis positive-direction side by a first predetermined amount or more, the lip portion 543a starts to slidably contact with the outer peripheral surface of the second large-diameter portion 521b (refer to FIG. 7). When the piston 52 is displaced toward the x-axis positive-direction side by a longer distance than a range of the second large-diameter portion 521b in the x-axis direction (a second predetermined amount larger than the first, predetermined amount) after the lip portion 543a starts to contact the outer peripheral surface of the second large-diameter portion 521b, the lip portion 543a starts to be positioned in the fixed volume chamber 514 without contacting the outer peripheral surface of the second large-diameter portion 521b (refer to FIG. 8).

Other configurations are similar to the first embodiment.

In the initial state illustrated in FIG. 6, the third piston seal 543 does not seal between the outer peripheral surface of the second large-diameter portion 521b and the inner peripheral surface of the cylinder 50 (the large-diameter portion 501). Both a hydraulic pressure in the fixed volume chamber 514 and the hydraulic pressure in the valuable volume chamber 513 are the atmospheric pressure P0. Further, the diameters of the first small-diameter portion 522 and the second small-diameter portion 527 are approximately equal to each other. Therefore, a force generated due to application of the hydraulic pressure in the fixed volume chamber 514 to the tapered portion 523b and a force generated due to application of the hydraulic pressure in the valuable volume chamber 513 to the surface 528 of the second large-diameter portion 521b are carried out by each other. Therefore, the force F3 is generated due to application of the hydraulic pressure in the fixed volume chamber 514 (the atmospheric pressure P0) in the region sandwiched by the first and second piston seals 541 end 542 to the tapered portion 523a. Therefore, F3=P0×(A1−A2) is satisfied. Accordingly, an equation similar to the first embodiment is acquired as a relational expression indicating the forces applied to the piston 52.

When the brake pedal 2 is operated, the volume of the variable volume chamber 513 is reduced and the third piston seal 543 also starts the above-described sealing. FIG. 7 is a diagram similar to FIG. 6 that illustrates the activation state of the stroke simulator 5 when the third piston seal 543 is exerting the seal function. The flow of the brake fluid is indicated by an alternate long and short dash line. The third piston seal 543 prohibits or reduces the flow of the brake fluid heading from the variable volume chamber 513 toward the fixed volume chamber 514. On the other hand, the second piston seal 542 permits the flow of the brake fluid heading from the variable volume chamber 513 toward the backpressure chamber 512. Therefore, the brake fluid is supplied from the variable volume chamber 513 to the backpressure chamber 512 while passing through the second piston seal 542. The hydraulic pressure in the variable volume chamber 513 is increased to around the hydraulic-pressure P2 in the backpressure chamber 512. The force generated due to the application of the hydraulic pressure in the fixed volume chamber 514 to the tapered portion 523b, and the force generated due to application of the hydraulic pressure in the fixed volume chamber 514 to the tapered portion 523a are canceled out by each other. Therefore, the force F3 is generated due to the application of the hydraulic pressure (the backpressure P2) in the variable volume chamber 513 in the region sandwiched by the first and second piston seals 541 and 542 to the surface 528. Therefore, F3=P2×(A1−A2) is satisfied. Since the force F2 is F2=P2×A2, the sum of the forces F2 and F3 is expressed as F2+F3=P2×A1. In other words, the forces are applied to the piston 52 while having a similar relational expression between them to the above-described comparative example in which the piston 52 is the non-stepped large-diameter piston (the pressure-receiving area of the piston 52 that receives the backpressure P2 is A1).

When the amount of the operation pressing the brake pedal 2 exceeds a predetermined operation amount (an amount corresponding to a sum of the above-described first predetermined amount and second predetermined amount), the third piston seal 543 releases the above-described sealing. FIG. 8 is a diagram similar to FIG. 6 that illustrates the activation state of the stroke simulator 5 when the third piston seal 543 stops exerting the seal function. The flow of the brake fluid is indicated by an alternate long and short dash line. The variable volume chamber 513 is in communication with the fixed volume chamber 514. Therefore, the hydraulic pressure in the variable volume chamber 513 is reduced to the hydraulic pressure P0 in the fixed volume chamber 514. According to the reduction in the volume of the variable volume chamber: 513, the brake fluid is delivered from the variable volume chamber 513 into the fixed volume chamber 514 while passing through the outer periphery of the large-diameter portion 521b. The brake fluid delivered into the fixed volume chamber 514 is returned to the reservoir tank 4 while passing through the communication oil passage 10. Similarly to the above-described initial state, the force F3 is generated due to the application of the hydraulic pressure P0 in the fixed volume chamber 514 in the region sandwiched by the first and second piston seals 541 and 542 to the tapered portion 523a. Therefore, F3=P0×(A1−A2) is satisfied. Therefore, the similar equation to the first embodiment is acquired as the relational expression indicating the forces applied to the piston 52.

In the above-described manner, the piston 52 is provided with the second large-diameter portion 521b, and allows the third piston seal 543 to seal between the second large-diameter portion 521b and the inner peripheral surface of the cylinder 50 (the large-diameter portion 501). As a result, while the third piston seal 543 is exerting the above-described seal function, the brake fluid is supplied from the variable volume chamber 513 to the backpressure chamber 512 according to the operation of pressing the brake pedal 2. In other words, as the volume of the variable volume chamber 513 is reduced due to the displacement of the second large-diameter portion 521b toward the x-axis positive-direction side, the pressure in the variable volume chamber 513 is increased. The second piston seal 542 permits the flow of the Drake fluid heading from the variable volume chamber 513 toward the backpressure chamber 512. Therefore, the brake fluid in the variable volume chamber 513 that is supplied from the fixed volume chamber 514 is supplied to the backpressure chamber 512 while passing through between the lip portion 542a as the one-way seal portion of the second piston seal 542 and the first small-diameter portion 522 of the piston 52. When the volume of the variable volume chamber 513 is increased according to the displacement of the second large-diameter portion 521b toward the x-axis negative-direction side, the variable volume chamber 513 has a negative pressure therein. The third piston seal 543 permits the flow of the brake fluid heading from the fixed volume chamber 514 toward the variable volume chamber 513. Therefore, the brake fluid in the fixed volume chamber 514 that is supplied from the communication oil passage 10 is supplied to the variable volume chamber 513 while passing through between the lip portion 543a as the one-way seal portion of the third piston seal 543 and the second large-diameter portion 521b the to the difference between the pressure in the fixed volume chamber 514 (the atmospheric pressure P0) and the pressure in the variable volume chamber 513 (the negative pressure). In other words, the one-way seal portion (the lip portion 542a) of the second piston seal 542 functions as a supply portion that supplies the brake fluid in the variable volume chamber 513 that is supplied from the communication oil passage 10 (the fixed volume chamber 514) to the backpressure chamber 512. The one-way seal portion (the lip portion 543a) of the third piston seal 543 functions as a second supply portion that supplies the brake fluid in the fixed volume chamber 514 that is supplied from the communication oil passage 10 to the backpressure chamber 512 via the variable volume chamber 513 and the second piston seal 542.

Therefore, at the time of the execution of the assist pressure increase control, the amount of the brake fluid supplied from the backpressure chamber 512 side (the third oil passage 13A) to the first oil passage 11B side (the third oil passage 13B) is larger than that in the first embodiment by the amount of the above-described brake fluid supplied from the variable volume chamber 513 to the backpressure chamber 512. In other words, at the time of the assist pressure increase control, while the third piston seal 543 is exerting the above-described seal function, the first small-diameter portion 522 of the piston 52 is displaced in the backpressure chamber 512 toward the x-axis positive-direction side. According thereto, the brake fluid flows out of the backpressure chamber 512 to the third oil passage 13A by an amount corresponding to a product of the second pressure-receiving area A2 and the stroke amount Sss of the piston 52. On the other hand, the brake fluid is supplied from the variable volume chamber 513 to the backpressure chamber 512 by an amount corresponding to a product of the difference between the first and second pressure-receiving areas (A1-A2) and Sss, and this amount of the brake fluid flows out of the backpressure chamber 512 to the third oil passage 13A. A sum of these brake fluid amounts (a brake fluid amount corresponding to a product of the first pressure-receiving area A1 and Sss) is supplied to the first oil passage 11B (the wheel cylinder 8) side. Therefore, the apparatus 1 can further efficiently assist the generation of the hydraulic pressure in the wheel cylinder 8 with use of the pump 7.

More specifically, generally, a brake fluid amount Qw supplied toward the wheel cylinder and the wheel cylinder hydraulic pressure Pw have such a relationship therebetween that ΔPw/ΔQw (the fluid stiffness), which is an amount of the increase in Pw with respect to the increase in Qw, is small in a low pressure region, and is large in a non-low pressure region in which the pressure is higher than in the above-described low pressure region. In the above-described low pressure region, a certain level of Qw is required until a space between the frictional member and the rotational member on the wheel side (a gap due to loose mounting) is filled. Further, in the above-described low pressure region, Pw is still low and the increase in Pw requires only a weak force but requires large Qw. On the other hand, in the above-described non-low pressure region, the filling-in (or stuffing) of the gap due to loose mounting has been completed, and a certain level of Pw has been generated. In the above-described non-low pressure region, the increase in Pw requires only small Qw but requires a strong force. Then, the responsiveness of the increase in the pressure in the wheel cylinder with use of the pump 7 becomes noticeably insufficient in the above-described low pressure region. In the present embodiment, the apparatus 1 can effectively improve the responsiveness or the increase in the pressure in the wheel cylinder 8 by performing the assist pressure increase control in such a low pressure region (i.e., at an initial stage of the increase in the pressure in the wheel cylinder 8), similarly to the first embodiment. For example, when detected Sp is Sp0 or smaller, Pw can be determined to be located in the above-described low pressure region. In other words, the increase in Pw requires only a relatively weak force, and can be sufficiently achieved by the pressing force Fp. Therefore, the apparatus 1 allows the assist pressure increase control to be performed. The apparatus 1 may determine whether Pw is located in the above-described low pressure region or the above-described non-low pressure region, based on Pw detected of the hydraulic sensor 92 instead of detected Sp.

Further, at least at an initial stage of a time period during which Pw is located in the above-described low pressure region, the apparatus 1 increases the effective pressure-receiving area on the backpressure side of the piston 52 from A2 to A1 as described above, and increases Qw by an amount corresponding thereto (regardless of the same Sp or Sas). Therefore, the apparatus 1 can further effectively improve the responsiveness of the increase in the pressure in the wheel cylinder 8. For example, the increase in Qw leads to a reduction in a time period until the filling-in of the gap is completed. While the pressure-receiving area is increased from A2 to A1, the pedal reaction force exceeds the pedal reaction force according to the first embodiment as much as this increase. However, the force required to increase Pw is sufficiently weak in the above-described low pressure region (especially at the initial stage of the time period during which Pw is located in the above-described low pressure region) as described above, so that the increase in the pedal reaction force does not raise a problem. It is preferable to limit the above-described second predetermined amount that; brings the lip portion 543a into sliding contact with the outer peripheral surface of the second large-diameter portion 521b so as to reduce this amount within a range required to realize the filling-up of the gap due to loose mounting. The above-described functional mechanism with the aid of the third piston seal 543 and the like is so-called functionally equivalent to a functional mechanism that would be constructed when a first-fill mechanism commonly used for master cylinders is provided to the stroke simulator. Therefore, the configuration of the first-fill mechanism commonly used for master cylinders may be provided to the stroke simulator. The present embodiment realizes the above-described function by combining the second large-diameter portion 521b of the piston 52 and the third piston seal 543 instead of directly applying the configuration of the first-fill mechanism in the master cylinder 3 to the stroke simulator 5. Therefore, the present embodiment can avoid an increase in the number of parts and complication of the structure.

In other words, in the piston 52, the second large-diameter portion 521b functions as the stepped portion for filling the gap due to loose mounting in the wheel cylinder 8. While the third piston seal 543 is exerting the above-described seal function, the piston 52 functions as a large-diameter piston similar to the above-described comparative example. Then, the third piston seal 543 starts to seal between the outer peripheral surface of the second large-diameter portion 521b and the inner peripheral surface of the cylinder 50 (the large-diameter portion 501) when the pressing operation is performed on the brake pedal 2. In other words, in the above-described initial state, the lip portion 543a of the third piston seal 543 does not contact the outer peripheral surface of the second large-diameter portion 521b. Therefore, after the pressing operation is performed, the third piston seal 543 starts the above-described sealing. The apparatus 1 may be configured in such a manner that the lip portion 543a is already in contact with the outer peripheral surface of the second large-diameter portion 521b in the above-described initial state. However, in the present embodiment, the lip portion 543a is not in contact with the outer peripheral surface of the second large-diameter portion 521b in the above-described initial state. Therefore, when the piston 52 starts to be displaced toward the x-axis positive-direction side according to the operation of pressing the brake pedal 2, a force generated due to the contact of the lip portion 543a to the second large-diameter portion 521b is removed from a maximum static frictional force applied to the piston 52. Therefore, the above-described maximum static frictional force is reduced. Thus, the apparatus 1 makes the displacement of the piston 52 further smooth at the initial stage of the activation of the stroke simulator 5. It is preferable to limit the above-described first predetermined amount that brings the lip portion 543a into sliding contact with the outer peripheral surface of the second large-diameter portion 521b so as to reduce this amount within a range required to make the start of the displacement of the piston 53 smooth. On the other hand, when the third piston seal 543 releases the above-described sealing, the piston 52 functions as a small-diameter piston similar to the first embodiment. In other words, the pressure-receiving area of the piston 52 on the backpressure side is reduced to a smaller area than the pressure-receiving area on the master cylinder 3 (the positive pressure) side. Therefore, after the gap due to loose mounting is filled, responsiveness when the hydraulic pressure P2 in the backpressure chamber 512 is increased similarly to the first embodiment, which can further improve the responsiveness of the increase in the pressure in the wheel cylinder 8.

FIG. 9 is a timing chart illustrating changes in the pedal pressing force Fp, the wheel cylinder hydraulic pressure Pw, and the pedal stroke Sp over time at the time of the execution of the assist pressure increase control. Pw according to the present embodiment is indicated by an alternate long and short dash line, and Pw according to the comparative example illustrated in FIG. 11 is indicated by a broken line. Sp according to the present embodiment is indicated by an alternate long and two short dashes line, and Sp according to the comparative example illustrated in FIG. 11 is indicated by a broken line. The brake pedal 2 starts to be pressed from time t0, and Fp is increased until time t2. After time t2, Fp is kept constant. After time t0, the apparatus 1 continues increasing the pressure in the wheel cylinder 8 by driving the pump 7. Assume that, after time t0, the apparatus 1 determines that the sudden brake operation is performed and continues performing the assist pressure increase control. From time t0 to time t1, the lip portion 543a of the third piston seal 543 is kept in contact with the outer peripheral surface of the piston 52 (the second large-diameter portion 521b) as long as Sp is Sp1 or smaller (FIG. 7), and the brake fluid is supplied from the variable volume chamber 513 to the backpressure chamber 512. The effective pressure-receiving area of the piston 52 on the backpressure side is A1, and the piston 52 functions as the large-diameter piston similar to the comparative example. According to the increase in Fp, Pw and Sp are increased while having a similar relationship therebetween to the comparative example. In the region where Sp is Sp1 or smaller, the increase in Pw (P2) requires only a relatively weak F1 (Pin) and can be sufficiently achieved by Fp. Therefore, the apparatus 1 can improve the responsiveness of the increase in the pressure in the wheel cylinder 8.

After time t1, when Sp is larger than Sp1, the lip portion 543a faces the fixed volume chamber 514 (FIG. 8), and the brake fluid is not supplied from the variable volume chamber 513 to the backpressure chamber 512. The effective pressure-receiving area of the piston 52 on the backpressure side is A2, and the piston 52 functions as the small-diameter piston similar to the first embodiment. According to the increase in Fp, Pw and Sp are increased while having a similar relationship therebetween to the first embodiment. In other words, larger Pw (P2) than the comparative example is generated with respect to the same pressing force Fp (Pm). Therefore, Pw is increased to the predetermined hydraulic pressure for a shorter time period (a response time period) than the comparative example as indicated by an arrow in FIG. 9. Further, F2 is weaker than the comparative example with respect to the same Pw (P2). Therefore, a weaker force than the comparative example is acquired as the pedal reaction forces corresponding to F2, as a result of which a large pedal stroke than the comparative example is generated as Sp even with respect to the same pressing force Fp. In other words, in the comparative example in which the diameter of the piston 52 is a large diameter and constant (there is no difference between the first and second pressure-receiving areas), Sp is increased very little even with the increase in Fp when Sp is larger than Sp1, provided that a lever ratio of the brake pedal 2 is a commonly-used lever ratio. If for example, if the assist pressure increase control is ended to bring the backpressure chamber 512 into communication with the reservoir tank 4 side instead of the wheel cylinder 8 side in order to approximately generate Sp, which results in deterioration of the responsiveness of the increase in the pressure in the wheel cylinder 8.

On the other hand, in the present embodiment, when Sp is larger than Sp1, the effective pressure-receiving diameter of the piston 52 is reduced to a small diameter (the effective pressure-receiving area is switched from A1 to A2 and is reduced) similarly to the first embodiment, as described above. Therefore, the apparatus 1 can appropriately increase Sp with respect to the increase in Fp even when the lever ratio of the brake pedal 2 is the commonly-used lever ratio. Therefore, the apparatus 1 can improve the pedal feeling while continuing the assist pressure increase control (without deteriorating the responsiveness of the increase in the pressure in the wheel cylinder 8 by ending the assist pressure increase control). Further, the apparatus 1 can improve the layout flexibility around the brake pedal 2 on the vehicle side. More specifically, a change in the lever ratio of the brake pedal 2 is prone to constraints from the layout around the brake pedal 2 on the vehicle side. The apparatus 1 can improve the pedal feeling while continuing the assist pressure increase control due to the setting of the diameter (A1 and A2) of the piston 52 and the like without changing the lever ratio of the brake pedal 2. Therefore, the apparatus 1 can improve the above-described layout flexibility. A booster for transmitting the pressing force Fp to the master cylinder 3 while amplifying it may be provided between the brake pedal 2 and the master cylinder 3. For example, a link-type variable booster capable of mechanically transmitting motive power between the brake pedal 2 and the master cylinder 3 and changing the boosting ratio may be provided. In the present embodiment, the apparatus 1 can improve the pedal feeling while continuing the assist pressure increase control even when the lever ratio of the brake pedal 2 is the commonly used lever ratio as described above. Therefore, no booster has to be added between the brake pedal 2 and the master cylinder 3. The apparatus 1 can also improve the above-described layout flexibility due to this feature.

Other advantageous effects are similar to the first embodiment.

### Third Embodiment

FIG. 10 is a diagram similar to FIG. 1 that schematically illustrates a configuration of the brake apparatus according to a third embodiment. The flow of the brake fluid when the brake pedal 2 is pressed at the time of a power failure is indicated by an alternate long and short dash line. The shut-off valve 21S is a normally-closed ON/OFF valve. A bypass oil passage 110S is provided in parallel with the first oil passage 11S while bypassing the shut-off valve 21S. A check valve 210 is provided in the bypass oil passage 110S. The check valve 210 permits a flew of the brake fluid heading from the secondary hydraulic pressure chamber 31S side (the first oil passage 11A) toward the wheel cylinder 8 side (the first oil passage 11B), and prohibits or reduces a flow of the brake fluid in an opposite direction therefrom. The stroke simulator IN valve SS/V IN 23 is a normally-opened electromagnetic valve provided in the third oil passage 13. The third oil passage 13 is divided into the oil passage 13A on the backpressure chamber 512 side and the oil passage 13B on the first oil passage 11B side by the SS/V IN 23. A bypass oil passage 130 is provided in parallel with the third oil passage 13 while bypassing the SS/V IN 23. The bypass oil passage 130 connects the oil passage 13A and the oil passage 13B to each other. A check valve 230 is provided in the bypass oil passage 130. The shock valve 230 permits a flow of the brake fluid heading from the backpressure chamber 512 side (the third oil passage 13A) toward the first oil passage 11B side (the third oil passage 13B), and prohibits or reduces a flow of the brake fluid in an opposite direction therefrom.

The assist pressure increase control unit 105 deactivates the SS/V IN 23 (controls the SS/V IN 23 in a valve-opening direction) and deactivates the SS/V OUT 24 (controls the SS/V OUT 24 in the valve-closing direction), thereby performing the assist pressure increase control. The wheel cylinder hydraulic control unit 104 controls the SS/V IN 23 in the valve-closing direction and controls the SS/V OUT 24 in the valve-opening direction to perform the normal boosting control (the wheel cylinder pressure increase control using the pump 7), thereby ending the assist pressure increase control.

Other configurations are similar to the first embodiment.

The SS/V OUT 24 and the SS/V IN 23 function as a switching unit that switches the connection between the connection between the backpressure chamber 512 and the first oil passage 11 and the connection between the backpressure chamber 512 and the low pressure portion (the reservoir tank 4 or the like) (switches the connection destination of the backpressure chamber 512 to the first oil passage 11 or the low pressure portion), similarly to the SS/V OUT 24 and the first SS/V IN 23 according to the first embodiment.

The apparatus 1 switches the communication state of the third oil passage 13 by controlling the activation state of the SS/V IN 23. By this switching, the apparatus 1 switches whether to supply the brake fluid from the backpressure chamber 512 to the wheel cylinder 8. By this operation, the apparatus 1 can arbitrarily switch whether to perform the assist pressure increase control. More specifically, the apparatus 1 blocks the communication between the backpressure chamber 512 and the first oil passage 11S (11B) by controlling the SS/V IN 23 in the valve-closing direction, thereby prohibiting the brake fluid flowing out of the backpressure chamber 512 from being used for the assist pressure increase control. As a result, the apparatus 1 can prohibit the assist pressure increase control from being performed (end the assist pressure increase control). Conversely, the apparatus 1 establishes the communication between the backpressure chamber 512 and the first oil passage 11S (11B) by controlling the SS/V IS 23 in the valve-opening direction, thereby allowing the brake fluid flowing out of the backpressure chamber 512 to be used for the assist pressure increase control. As a result, the apparatus 1 can allow the assist pressure increase control to be performed. The SS/V IN 23 may be a normally-closed valve. During the assist pressure increase control, when Nm exceeds Nm0 or Sp exceeds Sp0, i.e., Pw is determined to enter from the low pressure region to the non-low pressure region, the apparatus 1 controls the SS/V IN 23 in the valve-closing direction. As a result, the apparatus 1 can end the assist pressure increase control before P2 is excessively increased, thereby effectively preventing or reducing the deterioration of the pedal feeling. The apparatus 1 may be configured to control the SS/V IN 23 in the valve-closing direction at a timing before determining that Pw enters the non-low pressure region. In this case, the apparatus 1 can end the assist pressure increase control before P2 is excessively increased even if the SS/V IN 23 is actually closed late due to the control delay or the like, thereby preventing or reducing the deterioration of the pedal feeling.

The apparatus 1 easily allows the assist pressure increase control to be performed by switching the activation sates of the SS/V OUT 24 and the SS/V IN 23. In other words, the apparatus 1 can easily realize the switching between the state activating the stroke simulator 5 simply for creating the pedal reaction force (the wheel cylinder pressure increase control using only the pump 7) and the state activating the stroke simulator 5 for (also) improving tho responsiveness of the increase in the pressure in the wheel cylinder (the assist pressure increase control) by appropriately controlling the combination of activations of the SS/V OUT 24 and the SS/V IN 23. More specifically, the apparatus 1 prevents or reduces an inflow of the brake fluid from the first oil passage 11 side to the backpressure chamber 512 side and application of the relatively high hydraulic pressure on the first oil passage 11 side to the backpressure chamber 512, by closing the SS/V IN 23 when the SS/V OUT 24 is opened. As a result, the apparatus 1 can make the activation of the stroke simulator 5 smooth and realize the excellent pedal feeling. The apparatus 1 prevents or reduces a discharge of the brake fluid discharged from the backpressure chamber 512 to the reservoir tank 4 side by closing the SS/V OUT 24 when the SS/V IN 23 is opened. As a result, the apparatus 1 can increase the brake fluid amount to be supplied from the backpressure chamber 512 to the wheel cylinder 8 side via the first oil passage 11, thereby improving the responsiveness of the increase in the pressure in the wheel cylinder 8.

When the power failure has occurred in the apparatus 1, the motor 7a (the pump 7) is stopped and each of the electromagnetic valves 21 and the like is deactivated. The shut-off valve 21P of the P system is the normally-opened valve, and therefore is kept in the valve-opening state when the power failure has occurred. Therefore, as illustrated in FIG. 10, in the P system, the brake fluid is supplied from the primary hydraulic chamber 31P of the master cylinder 3 to the wheel cylinders 8a and 8d via the first oil passage 11P. On the other hand, the shut-off valve 218 of the S system is the normally-closed valve, and therefore is closed when the power failure has occurred. The SS/V IN 23 is the normally-opened valve, and therefore is opened when the power failure has occurred. The 33/V OUT 24 is the normally-closed valve, and therefore is closed when the power failure has occurred. Therefore, when the power failure has occurred, the brake fluid flows from the secondary hydraulic chamber 31S of the master cylinder 3 into the stroke simulator 5 (the positive pressure chamber 511) upon the pressing of the brake pedal 2, similarly to when the assist pressure increase control is performed. Further, the SS/V OUT 24 and the SS/V IN 23 switch the flow passage so as to connect the backpressure chamber 512 and the first oil passage 11 via the third oil passage 13. Since the backpressure chamber 512 is in communication with the first oil passage 11S via the third oil passage 13, the brake fluid delivered out of the backpressure chamber 512 is introduced into the wheel cylinders 8b and 8c. Therefore, in the S system, the brake fluid is not directly supplied from the master cylinder 3 to the wheel cylinders 8b and 8c but is (indirectly) supplied from the stroke simulator 5 (the backpressure chamber 512) to the wheel cylinders 8b and 8c. At this time, the shut-off valve 21S is closed, which causes the brake fluid to be efficiently supplied from the secondary hydraulic chamber 31S toward the backpressure chamber 512. Further, the SS/V OUT 24 is closed, which causes the brake fluid to be efficiently supplied from the backpressure chamber 512 toward the wheel cylinders 8. When the pressed brake pedal 2 is returned, the brake fluid basically flows in an opposite direction from the flow when the brake pedal 2 is pressed. At this time, the brake fluid is supplied from the variable volume chamber 513 to the backpressure chamber 512 and the secondary hydraulic chamber 31S, which is similar to the first embodiment (FIG. 5).

In this manner, when the power failure has occurred, the brake fluid is supplied from the stroke simulator 5 (the backpressure chamber 512) to the wheel cylinders 8b and 8c according to the brake pressing operation. Therefore, the apparatus 1 can generate high Pw in the wheel cylinders 8b and 8c, thereby improving the deceleration of the vehicle. In other words, appropriately setting the diameter of the piston 52 and the biasing force of the spring 53 allows the generation of P2 higher than Pm. More specifically, setting smaller A2 than A1 allows the generation P2 higher than P2 (Pm) as described in the first embodiment. Therefore, the apparatus 1 can improve efficiency of the force when increasing the pressure in the wheel cylinder 9 with use of the brake fluid flowing out of the backpressure chamber 512. Therefore, the apparatus 1 can improve the layout flexibility around the brake pedal 2 on the vehicle side while arbitrarily changing the boosting ratio (how high Pw is generated with respect to Fp or Pm) when the power failure has occurred. In other words, the apparatus 1 can increase the vehicle deceleration when the power failure has occurred due to the setting of the diameter of the piston 52 (A1 and A2) and the like without changing the lever ratio of the brake pedal 2. Further, no booster has to be added between the brake pedal 2 and the master cylinder 3. Therefore, the apparatus 1 can improve the above-described layout flexibility.

The apparatus 1 may control the opening/closing of each of the electromagnetic valves so as to attain a similar flow of the brake fluid to the present embodiment when a failure has occurred in the actuator (the motor 7a) for driving the hydraulic source (the pump 7), instead of when the power failure has occurred but also. More specifically, the apparatus 1 controls the SS/V OUT 24 and the SS/V IN 23 to switch the flow passage so as to connect the backpressure chamber 512 and the first oil passage 11 via the third oil passage 13. As a result, the apparatus 1 can establish a backup in case of the above-described failure and acquire a sufficient braking force. The apparatus 1 is configured in such a manner that each of the electromagnetic valves is provided so as to automatically realize the above-described flow of the brake fluid when no power is supplied, and therefore is especially effective when the power failure has occurred (the apparatus 1 can realize a mechanical backup).

The bypass oil passage 110S and the check valve 210 may be omitted. However, the apparatus 1 permits the flow of the brake fluid from the secondary hydraulic chamber 31S side (the first oil passage 11A) to the wheel cylinder 8 side (the first oil passage 11B) by the check valve 210 (the bypass oil passage 110S). Therefore, even if there is such a situation that Pm exceeds Pw with the shut-off valve 21S closed, the check valve 210 is opened, by which the brake fluid is supplied from the secondary hydraulic chamber 315 side (the firs toil passage 11A) to the wheel cylinder 8 side (the first oil passage 11B) via the bypass oil passage 110S. Therefore, the apparatus 1 can improve the responsiveness of the increase in the pressure in the wheel cylinder 8 at the time of the assist pressure increase control. Further, the apparatus 1 can efficiently and further swiftly generate the deceleration of the vehicle when the failure has occurred in the motor 7a.

The bypass oil passage 130 and the check valve 230 may be omitted. However, the apparatus 1 permits the flow of the brake fluid from the backpressure chamber 512 side (the third oil passage 13A) to the first oil passage 11B side (the third oil passage 13B) by the check valve 230 (the bypass oil passage 130). The check valve 230 is kept in the valve-opening state as long as the hydraulic pressure P2 on the backpressure chamber 512 side (the third oil passage 13A) with respect to the check valve 230 is higher than the hydraulic pressure Pw on the first oil passage 118 side (the third oil passage 13B). Therefore, the brake fluid is supplied from the backpressure chamber 512 side (the third oil passage 13A) to the wheel cylinder 8 side (the third oil passage 13B) via the bypass oil passage 130 regardless of the activation state of the SS/V IN 23. Therefore, the apparatus 1 can improve the responsiveness of the increase in the pressure in the wheel cylinder 8 at the time of the assist pressure increase control. Further, the apparatus 1 can efficiently and further swiftly generate the deceleration of the vehicle when the failure has occurred in the motor 7a. More specifically, since the flow passage area can be widened as much as the bypass oil passage 130 in addition to the third oil passage 13, the apparatus 1 can increase the brake fluid amount to be supplied from the backpressure chamber 512 toward the wheel cylinder 8 during the assist pressure increase control or when the failure has occurred in the motor 7a. Further, even if the apparatus 1 is configured) to control the SS/V IN 23 in the valve-closing direction (for example, in preparation for the boosting control) before starting the assist pressure increase control, and the SS/V IN 23 is opened late due to the control delay at the time of the start of the assist pressure increase control, the apparatus 1 allows the brake fluid to be supplied from the backpressure chamber 512 toward the wheel cylinder 8 via the bypass oil passage 130. Further, even if the SS/V IN 23 is closed in such a state that the capability of the pump 7 for supplying the brake fluid (pressure) is still insufficient (i.e., the SS/V IN 23 is closed at a too early timing) at the end of the assist pressure increase control, the apparatus 1 allows the brake fluid to be supplied from the backpressure chamber 512 toward the wheel cylinder 8 via the bypass oil passage 130 as long as P2 is higher than Pw.

The apparatus 1 may be adjusted so that Pw generated due to Fp when the failure has occurred in the motor 7a is generally equal between the P system and the S system. For example, a unit formed by the stroke simulator 5 and the third oil passage 13 may be set not only on the S system side but also in the oil passage on the P system side. Alternatively, a unit formed by the stroke simulator 5, the third oil passage 13, and the fourth oil passage 14 may be provided only in the oil passage on the P system side, and the diameter of the piston 32S of the S system in the master cylinder 3 may be changed to have different pressure-receiving areas of the piston 32S on the both ends thereof in the x-axis direction, thereby carrying out the boosting in such a manner that Pm (Pw) in the S system generally matches Pm (Pw) in the P system.

Other advantageous effects are similar to the first embodiment.

[Other Embodiments]

Having described how the present invention can be realized based on the embodiments thereof, the specific configuration of the present invention is not limited to the embodiments, and the present invention also includes a design modification and the like thereof made within a range that does not depart from the spirit of the present invention. For example, the brake apparatus (the brake system) to which the present invention is applied may be any brake apparatus including a mechanism for simulating the operation reaction force (the stroke simulator) and capable of increasing the pressure in the wheel cylinder with use of a hydraulic source other than the master cylinder, and is not limited to the brake apparatus in the embodiments. In the embodiments, the hydraulic wheel cylinder 8 is provided to each of the wheels, but the configuration of the brake apparatus is not limited thereto and the brake apparatus may be configured in such a manner that, for example, the hydraulic wheel cylinder is provided to the front wheel side and a caliper capable of generating the braking force with use of an electric motor is provided to the rear wheel side. Further, the method for activating each of the actuators for controlling Pw, such as the method for setting Nm (Nm*), is not limited to the method in the embodiments, and can be arbitrarily changed. Further, the individual components described in the claims and the specification can be arbitrarily combined or omitted within a range that allows them to remain capable of achieving at least a part of the above-described objects or producing at least a part of the above-described advantageous effects.

The present application claims priority to Japanese Patent Application No. 2014-251366 filed on Dec. 12, 2014. The entire disclosure of Japanese Patent Application No. 2014-251366 filed on Dec. 12, 2014 including the specification, the claims, the drawings, and the abstract is incorporated herein by reference in its entirety.

### REFERENCE SIGNS LIST

1 brake apparatus
3 master cylinder
4 reservoir tank
5 stroke simulator
50 cylinder
511 positive pressure chamber
512 backpressure chamber
52 piston
521 large-diameter portion
522 small-diameter portion
541 first piston seal (first separation seal member)
542 second piston seal (second separation seal member)
542a lip portion (supply portion)
543 third piston seal (third separation seal member)
7 pump (hydraulic source)
7a motor (driving source)
8 wheel cylinder
10 communication oil passage
11 first oil passage
12 second oil passage
13 third oil passage
14 fourth oil passage
23 stroke simulator IN valve (switching unit)
24 stroke simulator OUT valve (switching unit)

1. A brake apparatus comprising:
a hydraulic source configured to generate a hydraulic pressure in a wheel cylinder by generating a hydraulic pressure in a first oil passage with use of brake fluid supplied from a reservoir tank;
a stroke simulator including a piston configured to be activated axially in a cylinder with use of brake fluid supplied from a master cylinder, the piston dividing an inside of the cylinder into at least a positive pressure chamber and a backpressure chamber and being configured in such a manner that a pressure-receiving area facing the backpressure chamber is smaller than a pressure-receiving area facing the positive pressure chamber, the stroke simulator being configured to generate, through the activation of the piston, an operation reaction force according to a brake operation performed by a driver:
a second oil passage provided between the positive pressure chamber and the master cylinder:
a third oil passage connecting between the backpressure chamber and the first oil passage;
a fourth oil passage connecting between the backpressure chamber and the reservoir tank; and
a switching unit configured to switch a connection of the backpressure chamber between a connection between the backpressure chamber and the first oil passage and a connection between the backpressure chamber and the reservoir tank.

2. The brake apparatus according to claim 1, wherein the switching unit is a stroke simulator IN valve provided in the third oil passage and a stroke simulator OUT valve provided in the fourth oil passage.

3. The brake apparatus according to claim 2, wherein each of the valves is a control valve.

4. The brake apparatus according to claim 2, wherein the stroke simulator IN valve is a one-way valve that permits only a flow from the backpressure chamber to the first oil passage.

5. The brake apparatus according to claim 1, further comprising a separation seal member for sealing between the positive pressure chamber and the backpressure chamber.

6. The brake apparatus according to claim 5. wherein a large-diameter portion facing the positive pressure chamber and a small-diameter portion provided continuously from the large-diameter portion and facing the backpressure chamber are formed at the piston,
wherein the separation seal member includes a first separation seal member for sealing between an outer peripheral surface of the large-diameter portion and an inner peripheral surface of the cylinder, and a second separation member for seal rug between an outer peripheral surface of the small-diameter portion and the inner peripheral surface of the cylinder, and
wherein the brake apparatus further comprises:
a communication oil passage for establishing
communication of a region sandwiched by the first separation seal member and the second separation seal member in the cylinder with the reservoir tank; and
a supply portion for supplying the brake fluid supplied from the communication oil passage to the backpressure chamber.

7. The brake apparatus according to claim 6, wherein the second separation seal member includes tire supply portion, and the supply portion is a one-way seal portion for permitting only a flow of the brake fluid from the region to the backpressure chamber.

8. The brake apparatus according to claim 6, former comprising a third separation seal member for sealing between the outer peripheral surface of the large-diameter portion and the inner peripheral surface of the cylinder on the backpressure chamber side with respect to the communication oil passage in the region sandwiched by the first separation seal member and the second separation seal member.

9. The brake apparatus according to claim 8, wherein the third separation seal member starts to seal between the outer peripheral surface of the large-diameter portion and the inner peripheral surface of the cylinder when a brake pedal is operated.

10. The brake apparatus according to claim 9, wherein the third separation seal member releases the sealing when an amount of the operation performed on the brake pedal exceeds a predetermined operation amount.

11. The brake apparatus according to claim 1, further comprising a driving source for driving the hydraulic source,
wherein the switching unit switches the connection of the backpressure chamber between the connection between the backpressure chamber and the first oil passage and the connection between the backpressure chamber and the reservoir tank so as to connect between the backpressure chamber and the first oil passage via the third oil passage when a failure occurs in the driving source.

12. A brake apparatus comprising: a pump configured lo generate a hydraulic pressure is a wheel cylinder by generating a hydraulic pressure in a first oil passage with use of brake fluid supplied from a low pressure portion;
a stroke simulator including a separation member configured to be activated axially in a cylinder with use of brake fluid supplied from a master cylinder, the separation member liquid-tightly dividing an inside of the cylinder into a positive pressure chamber and a backpressure chamber and including a first pressure-receiving surface facing the positive pressure chamber and having a first pressure-receiving area and a second pressure-receiving surface facing tile backpressure chamber and having a second pressure-receiving area, the separation member being configured in such a manner that the first pressure-receiving area is larger than the second pressure-receiving area, the stroke simulator being configured to generate, through the activation of the separation member, an operation reaction force according to a brake operation performed by a driver;
a second oil passage provided between the positive pressure chamber and the master cylinder;
a third oil passage connecting between the backpressure chamber and the first oil passage;
a fourth oil passage connecting between the backpressure chamber and the low pressure portion; and
a switching unit configured to switch a connection destination of the backpressure chamber to the first oil passage or the low pressure portion.

13. The brake apparatus according to claim 12, wherein the switching unit is a stroke simulator IN valve provided in the third oil passage and a stroke simulator OUT valve provided in the fourth oil passage.

14. The brake apparatus according to claim 12, wherein a large-diameter portion facing the positive pressure chamber and a small-diameter portion provided continuously from the large-diameter portion and facing the backpressure chamber are formed at the piston.
wherein the brake apparatus further comprising:
a first separation seal member for sealing between an outer peripheral surface of the large-diameter portion and an inner peripheral surface of the cylinder, and a second separation member for sealing between an outer peripheral surface of the small-diameter portion and the inner peripheral surface of the cylinder;
a communication oil passage for establishing communication of a region sandwiched by the first separation seal member and the second separation seal member in the cylinder with the low pressure portion: and
a supply portion for supplying the brake fluid supplied from the communication oil passage to the backpressure chamber.

15. The brake apparatus according to claim 14, further comprising a third separation seal member for sealing between the outer peripheral surface of the large-diameter portion and
the inner peripheral surface of the cylinder on the backpressure chamber side with respect to the communication oil passage in a region sandwiched by the first separation seal member and the second separation seal member.

16. A brake system comprising:
a master cylinder configured in such a manner that a piston therein is activated according a brake operation performed by a driver to cause brake fluid to flow out of an inside thereof;
a stroke simulator including a piston configured to be activated axially in a cylinder with use of the brake fluid supplied from the master cylinder, the piston dividing an inside of the cylinder into a positive pressure chamber and a backpressure chamber, the piston including a first pressure-receiving surface facing the positive pressure chamber and having a first pressure-receiving area and a second pressure-receiving surface facing the backpressure chamber and having a second pressure-receiving area larger than the first pressure-receiving area;
a pump configured to generate a hydraulic pressure in a wheel cylinder by generating a hydraulic pressure in a first oil passage with use of brake fluid supplied from a source other than the master cylinder;
a second oil passage provided between the positive pressure chamber and the master cylinder;
a third oil passage connecting between the backpressure chamber and the first oil passage;
a fourth oil passage connecting between the backpressure chamber and a low pressure portion; and
a switching unit configured to switch a connection of the backpressure chamber between a connection between the backpressure chamber and the first oil passage and a connection between the backpressure chamber and the low pressure portion.

17. The brake system according to claim 16, wherein the master cylinder and the stroke simulator are an integrally configured unit.

18. The brake system according to claim 17, wherein the piston of the master cylinder and the piston of the stroke simulator are disposed on a same central axis.

19. The brake system according to claim 17, wherein the pump is configured separately from the unit, and the pump and the unit are connected to each other via a pipe.
